(19) United States
(12) Patent Application Publication
(10) Pub. No.: US 2019/0310506 A1
(43) Pub. Date: Oct. 10, 2019

(54) LIQUID CRYSTAL DISPLAY APPARATUS AND METHOD FOR MANUFACTURING LIQUID CRYSTAL DISPLAY APPARATUS

(71) Applicant: Mitsubishi Electric Corporation, Tokyo (JP)

(72) Inventors: Hideki NOGUCHI, Kumamoto (JP); Toshihiko IWASAKA, Kumamoto (JP)

(73) Assignee: Mitsubishi Electric Corporation, Tokyo (JP)

(21) Appl. No.: 16/351,907

(22) Filed: Mar. 13, 2019

(30) Foreign Application Priority Data
Apr. 4, 2018 (JP) 2018-072491

(51) Int. Cl. G02F 1/1343; G02F 1/1362; G02F 1/1368

(52) U.S. Cl. CPC G02F 1/13439; G02F 1/136286; G09G 3/3648; G02F 1/1368; G02F 1/134363; G02F 1/136259

(57) ABSTRACT

In forming a counter electrode in an FFS type liquid crystal display apparatus, a slit is not provided in a first pixel in which it has been found, in advance, that a bright spot defect is to occur by a defect inspection apparatus or the like. In the pixel without the slit, since a fringe electric field that has possibly occurred near the slit does not occur, a black spot defect can be obtained even if a signal potential is inputted to a pixel electrode.

### BACKGROUND OF THE INVENTION

### Field of the Invention

The present invention relates to a display apparatus, and particularly to a liquid crystal display apparatus having a liquid crystal display panel.

### Description of the Background Art

Liquid crystal display panels are used in many fields such as televisions, car navigation systems, and computers, because of their characteristics such as light weight, thin shape, and low power consumption. In recent years, liquid crystal display panels with higher definition or larger screen are being produced, and the number of pixels in the panel also tends to increase. Generally, increasing in number of pixels also increases incidence of defects that adversely affect the display, which leads to an increase in cost by lowering production yield. For this reason, the defects have been recovered by repairing, or converted to defects with higher tolerance.

As one such repair method, there is known a method of converting a bright spot defect into a black spot defect. Here, the bright spot defect means a defect in which there are brightly lit pixels even when display on a liquid crystal panel is in a black display state. Whereas, the black spot defect means a defect in which there are pixels that are not lit even when display on the liquid crystal panel is in a white display state. In general, since the bright spot defect is easier to see than the black spot defect, repair may be performed in which the bright spot defect is converted into the black spot defect (turned to a black spot) in some cases.

Various techniques are known as such repair methods. For example, there is also known a method of altering a color of a coloring matter constituting a color filter into black (see, Japanese Patent Application Laid-Open No. 2007-102223). Whereas, there is also known a method of electrically changing to a black spot rather than light shielding in appearance.

For example, there is known a technique of cutting off a connection between a thin film transistor (TFT) and a pixel electrode that are formed on an array substrate of a liquid crystal display panel, with means such as a laser (see, Japanese Patent Application Laid-Open No. 2009-151093). Further, in a case of a horizontal electric field type liquid crystal display panel such as an FFS type or an in-plane-switching type, there is known a technique of short-circuiting a pixel electrode and a counter electrode (common electrode) on an array substrate (see, Japanese Patent Application Laid-Open No. 2010-145667).

### SUMMARY

Since the method of altering a color of a coloring matter constituting a color filter to black can be performed after lighting inspection, a bright spot defect can be reliably grasped. However, there has been a problem that control of altering into black is difficult and takes time.

In addition, the method of cutting off a connection between the thin film transistor and the pixel electrode is breakage in principle. This causes breakage of surroundings or conduction due to adhesion of a conductive material scattered around. Further, the method of short-circuiting the pixel electrode and the counter electrode (common electrode) has a problem that it is difficult to reduce a connection resistance between the pixel electrode and the counter electrode (common electrode). As described above, the prior art for converting a bright spot defect into a black spot defect (turning to a black spot) has problems that it is difficult to control, a new problem occurs, and it is difficult to reliably convert.

It is an object of the present invention to provide a technique capable of converting a bright spot defect into a black spot defect in a fringe field switching type liquid crystal display panel.

According to the present invention, there are provided: a gate wiring and a source wiring that cross each other in a display area of an array substrate; a pixel, in the display area, having at least one switching element connected to the gate wiring and the source wiring, and a pixel electrode; and a counter electrode facing the pixel electrode via an insulating film. Further, a slit is formed in at least one of the pixel electrode and the counter electrode; the pixel includes a first pixel and a second pixel; and an area of a slit of the first pixel is less than 10% of an area of a slit of the second pixel.

It is possible to convert a bright spot defect into a black spot defect without cutting or short-circuiting.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a configuration of a TFT array substrate used in a liquid crystal display apparatus according to an embodiment;

FIG. 2 is a plan view showing a pixel configuration of a TFT array substrate according to a first preferred embodiment;

FIGS. 3, 4A and 4B, 5A and 5B, and 6 are cross-sectional views showing a pixel configuration of the TFT array substrate according to the first preferred embodiment;

FIGS. 7A and 7B, 8A and 8B, 9A and 9B, 10A and 10B, 11A and 11B, 12A and 12B, 13A and 13B, 14A and 14B, 15A and 15B, 16A and 16B, 17A and 17B, and 18A and 18B are cross-sectional views showing one manufacturing process of the TFT array substrate according to the first preferred embodiment;

FIGS. 19A and 19B, 20A and 20B, and 21A and 21B are cross-sectional views showing one manufacturing process of a TFT array substrate according to a modification of the first preferred embodiment;

FIGS. 22A and 22B, 23A and 23B, 24A and 24B, 25A and 25B, and 26A and 26B are cross-sectional views showing one manufacturing process of a TFT array substrate according to a second preferred embodiment;

FIGS. 27A and 27B, 28A and 28B, and 29A and 29B are cross-sectional views showing one manufacturing process of a TFT array substrate according to a modification of the second preferred embodiment;

FIGS. 30A and 30B, 31A and 31B, 32A and 32B, 33A and 33B, 34A and 34B, and 35A and 35B are cross-sectional views showing one manufacturing process of a TFT array substrate according to a third preferred embodiment; and

FIGS. 36, 37, 38, 39, 40, 41, and 42 are cross-sectional views showing a failure mode causing a bright spot defect.

### DESCRIPTION OF THE PREFERRED EMBODIMENTS

### First Preferred Embodiment

The following description is for describing embodiments of the present invention, and the present invention is not limited to the following embodiments. For clarity of description, the following description and drawings are omitted and simplified as appropriate. Further, for clarity of description, redundant description is omitted as necessary. Moreover, those denoted by the same reference numerals in the individual drawings indicate similar elements, and description thereof is appropriately omitted.

First, a liquid crystal display apparatus will be described. As will be described later, the liquid crystal display apparatus is formed by incorporating a liquid crystal display panel, a driving circuit, a backlight (light source), and the like into a housing. The liquid crystal display panel is formed by bonding an array substrate and a counter substrate such that a liquid crystal material is enclosed inside thereof. The liquid crystal display apparatus according to the present embodiment is an FFS mode liquid crystal display apparatus in which both a pixel electrode and a counter electrode (common electrode) are formed on an array substrate. Since a thin film transistor is usually used as a switching element on the array substrate, the array substrate is sometimes referred to as a TFT array substrate.

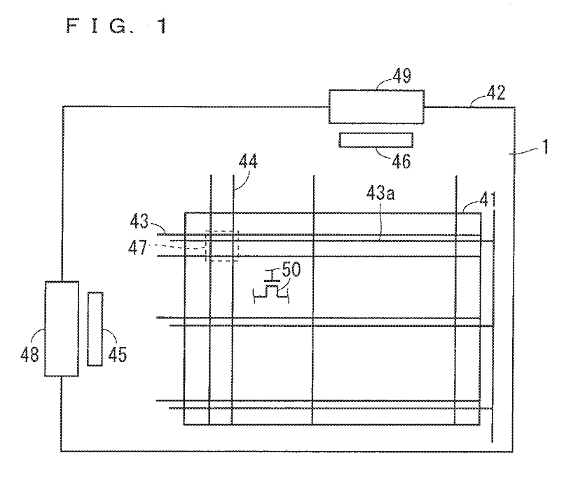

FIG. 1 is a front view showing a configuration of a TFT array substrate used in the liquid crystal display apparatus. This TFT array substrate is formed by using a substrate 1 of glass or the like. A region of the substrate 1 is sectioned into a display area 41 and a frame area 42 surrounding the display area 41. The display area 41 is a region corresponding to a display unit of the display apparatus. First, the display area 41 will be described.

In the display area 41, a plurality of gate wirings (scanning signal lines) 43 and a plurality of source wirings (display signal lines) 44 are formed. In addition, a plurality of common wirings 43a are also formed in parallel to the gate wirings 43, and the plurality of common wirings 43a are connected to each other. The plurality of gate wirings 43 are provided in parallel to each other, the plurality of source wirings 44 are also provided in parallel to each other, and the plurality of gate wirings 43 and the plurality of source wirings 44 are provided so as to cross each other. In FIG. 1, as an example, a region surrounded by a pair of adjacent gate wirings 43 and a pair of adjacent source wirings 44 is defined as a pixel 47. Therefore, in the display area 41, the pixels 47 are arranged in a matrix shape.

Each pixel 47 is formed with at least one TFT 50 as a switching element. The TFT 50 is disposed near an intersection of the gate wiring 43 and the source wiring 44, and the TFT 50 has a gate electrode connected to the gate wiring 43, a source electrode connected to the source wiring 44, a drain electrode connected to a pixel electrode (not shown).

The TFT 50 is turned ON in response to a gate signal supplied from the gate wiring 43, and applies a display voltage (display data) supplied to the source wiring 44 at this time to the pixel electrode. The pixel electrode is arranged oppositely to the counter electrode having a slit via an insulating film, and a fringe electric field corresponding to the display voltage is generated between the pixel electrode and the counter electrode. Although not shown, an alignment film is formed on a surface of the substrate 1 (a surface facing the liquid crystal). A detailed configuration of the pixel 47 will be described later.

Next, the frame area 42 will be described. In the frame area 42 of the substrate 1, a scanning signal driving circuit 45 and a display signal driving circuit 46 are provided. Although not shown in detail, the gate wiring 43 extends from the display area 41 to the frame area 42, and is connected to the scanning signal driving circuit 45 via a gate terminal formed at an end of the substrate 1. Similarly, the source wiring 44 also extends from the display area 41 to the frame area 42, and is connected to the display signal driving circuit 46 via a source terminal formed at an end of the substrate 1. Although not shown, the gate terminal pad and the source terminal pad made of a transparent conductive film or the like are respectively formed at the gate terminal and the source terminal.

Although not shown, the scanning signal driving circuit 45 and the display signal driving circuit 46 are also connected to the common wiring 43a, to maintain the common wiring 43a to have a common potential. Further, an external wiring 48 is connected near the scanning signal driving circuit 45 of the substrate 1, and an external wiring 49 is connected near the display signal driving circuit 46. The external wirings 48 and 49 are wiring substrates such as a flexible printed circuit (FPC), for example.

Various signals from outside are supplied to the scanning signal driving circuit 45 and the display signal driving circuit 46 via the external wirings 48 and 49. The scanning signal driving circuit 45 supplies a gate signal (scanning signal) to each gate wiring 43 based on a control signal from outside. This allows the gate wirings 43 to be sequentially selected. The display signal driving circuit 46 supplies a display signal to each source wiring 44 based on a control signal and display data from outside. This allows a display voltage corresponding to the display data to be supplied to each pixel 47.

In the liquid crystal display apparatus, the counter substrate is arranged to face a front side (viewing side) of the TFT array substrate described above. The counter substrate may be a so-called “color filter substrate” formed with a color filter, a black matrix (BM), an alignment film, and the like. Between the TFT array substrate and the counter substrate, a liquid crystal layer is sandwiched. That is, a liquid crystal is introduced between the substrate 1 and the counter substrate. Further, on an outer surface of the substrate 1 and the counter substrate, a polarizing plate, a retardation plate, and the like are provided. In addition, on a back side (opposite to the viewing side) of the liquid crystal display panel, a backlight unit and the like are disposed.

Here, in the FFS type applied to the liquid crystal display apparatus according to the present embodiment, the liquid crystal between the TFT array substrate and the counter substrate is driven by a fringe electric field generated between the pixel electrode and the counter electrode. That is, the fringe electric field changes an alignment direction of the liquid crystal, and changes a polarization state of light emitted from the backlight and passing through the liquid crystal layer. More specifically, the light from the backlight unit is linearly polarized by the polarizing plate on the array substrate side (back side), and when this linearly polarized light passes through the liquid crystal layer, the polarization state thereof is changed.

An amount of light passing through the polarizing plate on the counter substrate side (viewing side) is changed depending on the polarization state of the light passing through the liquid crystal layer. The polarization state of the light depends on the alignment direction of the liquid crystal, and the alignment direction of the liquid crystal is changed in accordance with a display voltage that is applied to the pixel electrode to generate a fringe electric field. Therefore, controlling the display voltage enables change of the amount of light passing through the polarizing plate on the viewing side. Therefore, changing the display voltage for each pixel enables display of a desired image.

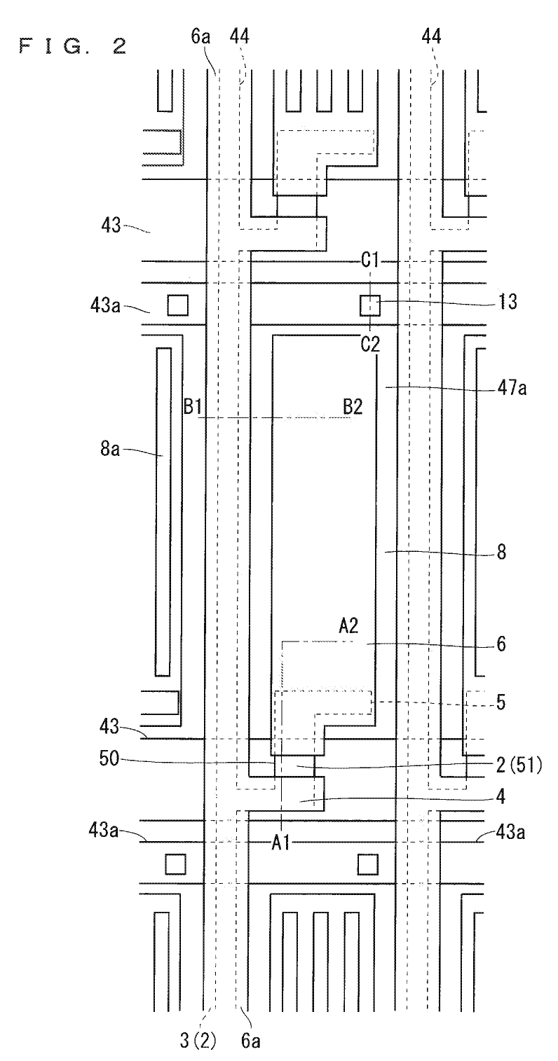

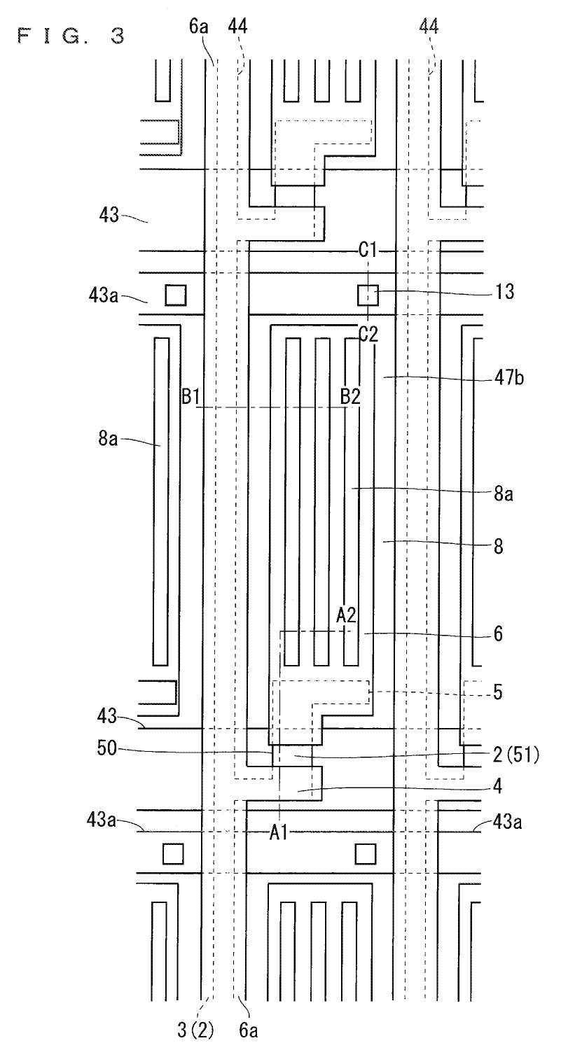

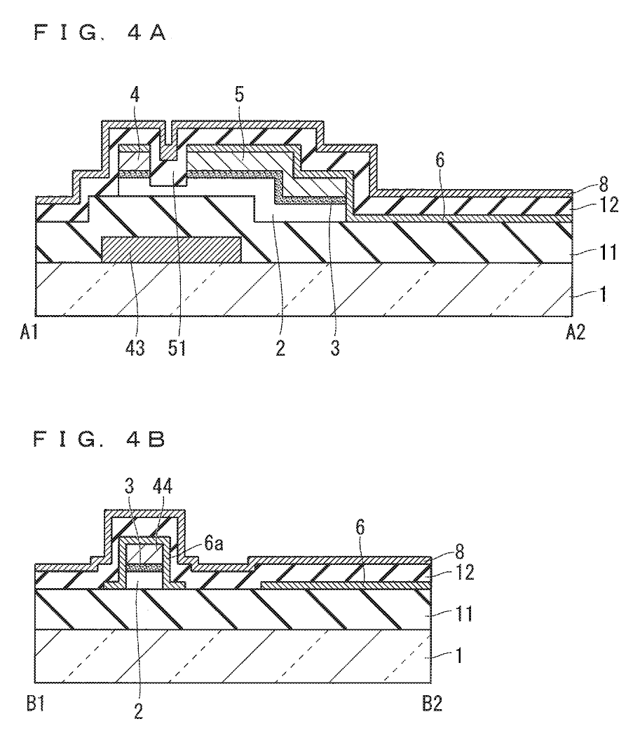

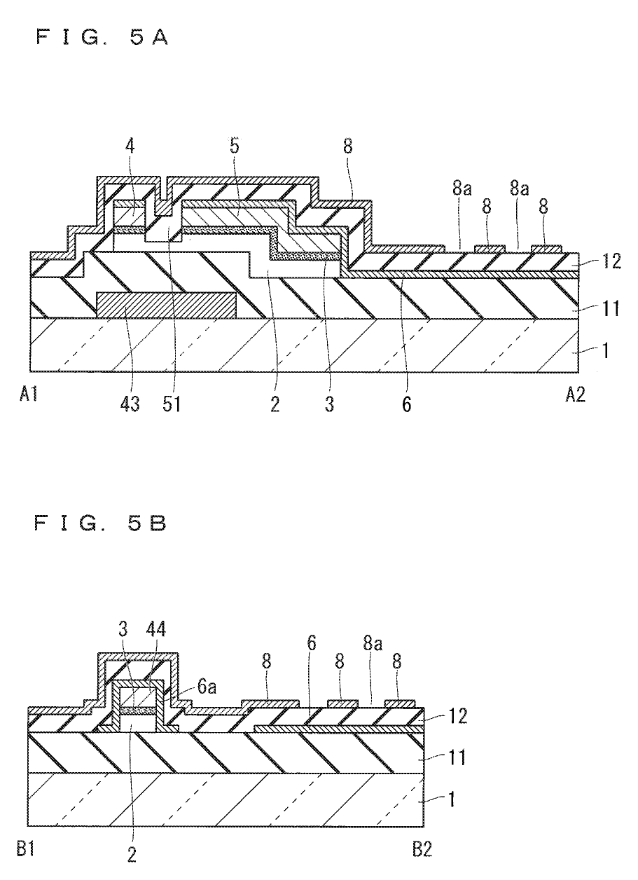

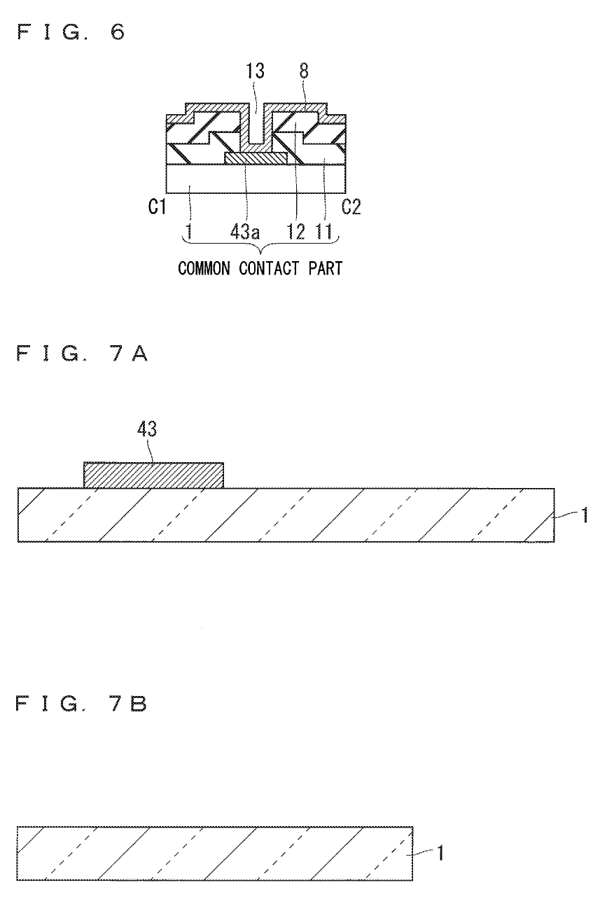

Subsequently, a pixel configuration of the TFT array substrate constituting the liquid crystal display apparatus will be described with reference to FIGS. 2 to 5A and 5B. FIGS. 2 and 3 are plan views showing a pixel configuration of the TFT array substrate according to the present embodiment. FIGS. 4A and 5A are cross-sectional views of a formation area (hereinafter referred to as “TFT to pixel electrode part”) from the TFT to a part of the pixel electrode and the counter electrode on the TFT array substrate, and respectively correspond to cross sections taken along line A1-A2 in FIGS. 2 and 3. FIGS. 4B and 5B are cross-sectional views of the source wiring and a part of the pixel electrode and the counter electrode (hereinafter referred to as “source wiring/pixel electrode part”) on the TFT array substrate, and respectively correspond to cross sections taken along line B1-B2 in FIGS. 2 and 3. FIG. 6 is a cross-sectional view of a formation area of a contact hole (hereinafter referred to as “contact hole part”) between the common wiring and the counter electrode on the TFT array substrate, and corresponds to a cross section taken along line C1-C2 in FIG. 2 or FIG. 3.

Here, a pixel 47a shown in a center in FIG. 2 and a pixel shown in FIGS. 4A and 4B are pixels according to the present embodiment, that is, the pixels correspond to pixels subjected to repair in which a bright spot defect is converted into a black spot defect. Whereas, FIGS. 3 and 5A and 5B show a pixel arranged other than the center in FIG. 2, that is, pixel not subjected to the above repairing. In the present embodiment, the repaired pixel and the unrepaired pixel are mixed in the display area. Therefore, in the following description, descriptions will be given without particularly contrasting for contents common to both structures, and descriptions will be given with contrasting for a difference. Further, in FIG. 2, the pixel 47a shown in the center may be referred to as a first pixel, and a pixel 47b illustrated in FIG. 3 may be referred to as a second pixel.

As shown in FIGS. 2 to 5A and 5B, a plurality of gate wirings 43 connected to the gate electrode of the TFT 50 are formed on the substrate 1 made of an insulating material, such as a glass substrate. In the present embodiment, a part of the gate wiring 43 functions as a gate electrode of the TFT 50. The plurality of gate wirings 43 are disposed linearly in parallel to each other. Further, on the substrate 1, the plurality of common wirings 43a formed by using the same wiring layer as the gate wiring 43 are formed in parallel. The common wiring 43a is disposed between the gate wirings 43, substantially in parallel with the gate wiring 43.

A first metal film constituting these gate wirings 43 (gate electrodes) and the common wirings 43a is, for example, formed by Cr, Al, Ta, Ti, Mo, W, Ni, Cu, Au, Ag, or the like, an alloy film mainly containing any of these, or a laminated film of any of these.

On the gate wiring 43 and the common wiring 43a, a gate insulating film 11 as a first insulating film is formed. The gate insulating film 11 is formed of an insulating film such as silicon nitride, silicon oxide, or the like.

On the gate insulating film 11, a semiconductor film 2 is formed. As shown in FIGS. 4A and 4B, the semiconductor film 2 is also disposed under the source wiring 44, and is formed in a linear shape crossing the gate wiring 43 in accordance with a formation area of a source electrode 4. A pattern of the semiconductor film 2 under the source wiring 44 is orthogonal to the gate wiring 43. The semiconductor film 2 is formed of amorphous silicon, polycrystalline silicon, an oxide semiconductor material such as In—Ga—Zn—O, or the like.

The linear semiconductor film 2 also functions as a redundant wiring of the source wiring 44. That is, even when the source wiring 44 is disconnected, interruption of the electric signal can be inhibited by disposing the semiconductor film 2 along the source wiring 44. The linear semiconductor film 2 may also function as a redundant wiring together with an ohmic contact film 3 to be described later.

Further, a part of the linear semiconductor film 2 branches at the intersection with the gate wiring 43, extends along the gate wiring 43, and further extends into the pixel 47. The TFT 50 is formed by using a portion of the semiconductor film 2 branched from the intersection with the gate wiring 43. That is, in the branched semiconductor film 2, a portion overlapping with the gate wiring 43 (gate electrode) is to be an active region constituting the TFT 50. The semiconductor film 2 is formed of, for example, amorphous silicon, polycrystalline polysilicon, an oxide semiconductor material such as In—Ga—Zn—O, or the like.

On the semiconductor film 2, the ohmic contact film 3 doped with a conductive impurity is formed. The ohmic contact film 3 is formed on substantially the entire surface of the semiconductor film 2, but is removed at a portion to be a channel region of the TFT 50 (a region between the source electrode 4 and a drain electrode 5). The ohmic contact film 3 is formed of, for example, n-type amorphous silicon or n-type polycrystalline silicon doped with an impurity such as phosphorus (P) at a high concentration. In a case where the semiconductor film 2 is made of an oxide semiconductor material, formation of the ohmic contact film may be unnecessary.

In a portion overlapping with the gate wiring 43, of the semiconductor film 2, a region formed with the ohmic contact film 3 is to be source and drain regions. Referring to FIGS. 4A and 4B, in the semiconductor film 2, a region overlapping with the gate wiring 43 under the ohmic contact film 3 on the left is the source region, and a region overlapping with the gate wiring 43 under the ohmic contact film 3 on the right is the drain region. Then, a region sandwiched between the source region and the drain region in the semiconductor film 2 is a channel region 51.

On the ohmic contact film 3, the source wiring 44, the source electrode 4, and the drain electrode 5 are formed by using a same wiring layer. In the TFT part, as shown in FIGS. 4A and 4B, the source electrode 4 is formed on the ohmic contact film 3 on the source region side of the TFT 50, and the drain electrode 5 is formed on the ohmic contact film 3 on the drain region side. The TFT 50 having such a configuration is called “channel etch TFT”. In the source wiring/pixel electrode part, as shown in FIGS. 4A and 4B, the source wiring 44 is formed on the semiconductor film 2 via the ohmic contact film 3, and disposed so as to linearly extend in a direction crossing the gate wiring 43.

The source electrode 4 and the drain electrode 5 of the TFT 50 are separated, but the source electrode 4 is connected to the source wiring 44. That is, the source wiring 44 branches at the intersection with the gate wiring 43 to extend along the gate wiring 43, and the extended portion becomes the source electrode 4. Similarly to the ohmic contact film 3, the conductive film constituting the source wiring 44, the source electrode 4, and the drain electrode 5 is formed on substantially the entire surface of the semiconductor film 2, but is removed at a portion to be the channel region 51 of the TFT 50.

In the present embodiment, for example, a second conductive film constituting the source wiring 44, the source electrode 4, and the drain electrode 5, is formed by Cr, Al, Ta, Ti, Mo, W, Ni, Cu, Au, Ag, or the like, an alloy film mainly containing any of these, or a laminated film of any of these.

As can be understood from the above description, the semiconductor film 2 is disposed over substantially the entire region under the source wiring 44, the source electrode 4, and the drain electrode 5, and in the channel region 51 between the source electrode 4 and the drain electrode 5 located on the gate wiring 43. Further, the ohmic contact film 3 is disposed between the semiconductor film 2 and each of the source wiring 44, the source electrode 4, and the drain electrode 5.

The drain electrode 5 is electrically connected to a pixel electrode 6 formed on substantially the entire surface of a region of the pixel 47 (a region surrounded by the source wiring 44 and the gate wiring 43). The pixel electrode 6 is formed of a transparent conductive film such as indium tin oxide (ITO).

As shown in FIGS. 2 to 5A and 5B, the pixel electrode 6 has a portion directly overlapped on the drain electrode 5. That is, in that portion, a lower surface of the pixel electrode 6 is in direct contact with an upper surface of the drain electrode 5. In addition, the pixel electrode 6 covers substantially the entire surface on the drain electrode 5. However, an end on the channel region side of the pixel electrode 6 is arranged at substantially the same position as an end on the channel region side of the drain electrode 5. Therefore, an end face on the channel region side of the drain electrode 5 is not covered with the pixel electrode 6.

In this way, by adopting a configuration in which a part of the pixel electrode 6 is directly overlapped on the drain electrode 5 without interposing an insulating film, a contact hole for electrically connecting the pixel electrode 6 and the drain electrode 5 becomes unnecessary, and a photoengraving process can be reduced. In addition, since it becomes unnecessary to secure an area where the contact hole is arranged, there is also an advantage that an opening ratio of the pixel 47 can be increased.

Further, as shown in FIGS. 2 to 5A and 5B, a first transparent conductive film pattern 6a, which is in the same layer as the pixel electrode 6, is also formed overlapping directly over substantially the entire surface of the source electrode 4 and the source wiring 44. An end on the channel region side of the first transparent conductive film pattern 6a on the source electrode 4 is arranged at substantially the same position as an end on the channel region side of the source electrode 4. Therefore, the end on the channel region side of the source electrode 4 is not covered with the first transparent conductive film pattern 6a.

In this way, the first transparent conductive film pattern 6a in the same layer as the pixel electrode 6 is formed on substantially the entire surface over the source wiring 44, the source electrode 4, and the drain electrode 5 that are formed by using the first metal film. In particular, the first transparent conductive film pattern 6a on the source wiring 44 also functions as a redundant wiring of the source wiring 44. That is, even when the source wiring 44 is disconnected, interruption of the electric signal can be inhibited by disposing the first transparent conductive film pattern 6a along the source wiring 44.

Top of the pixel electrode 6 (the first transparent conductive film pattern 6a) is covered with an interlayer insulating film 12, which is a second insulating film. The interlayer insulating film 12 is formed of silicon nitride, silicon oxide, or the like. On the interlayer insulating film 12, a counter electrode 8 made of a second transparent conductive film such as ITO is formed. The interlayer insulating film 12 functions as a protective film of the TFT 50, and also functions as an interlayer insulating film between the pixel electrode 6 and the counter electrode 8. The counter electrode 8 is formed over the entire surface at least within the display area 41 of the TFT array substrate except for a slit 8a. Therefore, the counter electrode 8 faces the pixel electrode 6 via the interlayer insulating film 12 in a film thickness direction.

Here, since the counter electrode 8 is a significant element in the present embodiment, details thereof will be described later, and a connection structure between the counter electrode 8 and the common wiring 43a will be described first. As shown in FIG. 6, the counter electrode 8 is electrically connected to the common wiring 43a that is supplied with a common potential via a contact hole 13 passing through the interlayer insulating film 12 and the gate insulating film 11.

Hereinafter, a structure of the second pixel will be described by comparing with a structure of the first pixel according to the present embodiment. As shown in FIGS. 3 and 5A and 5B, in the second pixel 47b the counter electrode 8 is arranged oppositely to the pixel electrode 6 via the interlayer insulating film 12, and provided with the slit 8a for generation of a fringe electric field between with the pixel electrode 6. Since a fringe electric field is generated between the pixel electrode 6 and the counter electrode 8 near the slit 8a, normal display is performed by controlling an alignment direction and a polarization state of the liquid crystal.

Whereas, as shown by the pixel 47a in FIG. 2, in the first pixel according to the present embodiment, the slit 8a is not formed in the counter electrode 8. While a manufacturing method will be described later, this is a structure in which there is no slit in a pixel in which it has been found, by inspection in advance, that a bright spot defect is to occur.

By thus intentionally leaving the counter electrode 8 in the plate shape without providing the slit 8a, a fringe electric field is not to be generated between the counter electrode 8 and the pixel electrode 6, even when the TFT 50 is turned ON in accordance with a gate signal supplied from the gate wiring 43 and a display voltage (display data) supplied to the source wiring 44 is applied to the pixel electrode 6.

For this reason, light from the backlight unit does not pass through the liquid crystal layer since the light is not linearly polarized even with the polarizing plate on the array substrate side (back side), and the polarization state does not change.

Further, an amount of light passing through the polarizing plate on the counter substrate side (viewing side) is not changed because no fringe electric field is generated in the first pixel. Here, the liquid crystal display panel according to the present embodiment is a normally black panel in which black spots are displayed when no fringe electric field is generated. That is, the first pixel 47 is a black display pixel. Such a structure enables repair of a pixel that has possibly caused a bright spot defect to a black spot defect.

In the present embodiment, the structure having no slit of the counter electrode has been illustrated and described, but, it is not limited to a structure having no slit at all. Even if an area of the slit is made smaller than that of the second pixel by partially eliminating the slit, the bright spot can be turned to a black spot by the elimination. In order to convert a bright spot defect into a black spot defect, it is desirable to reduce the slit area by 90% or more.

Further, in this first preferred embodiment, the structure has been described in which the counter electrode is located in an upper layer than that of the pixel electrode. However, the first preferred embodiment may also be applied to a structure in which, on the contrary, the pixel electrode is in an upper layer than that of the counter electrode. In this case, an object not formed with the slit is a pixel electrode rather than a counter electrode.

Further, in FIGS. 2 and 3, the configuration has been described in which the counter electrode 8 is connected over the entire surface within the display area 41, but the shape of the counter electrode 8 is not limited to this. As shown in FIGS. 2 and 3, since the counter electrode 8 of each pixel 47 is electrically connected to the common wiring 43a via the contact hole 13, the counter electrodes 8 of the respective pixels 47 adjacent to each other with the gate wiring 43 interposed in between may be separated from each other, as long as a same signal (voltage) is applied to each of the common wirings 43a. Further, the counter electrode 8 may be separated for each pixel.

A direction of the slit of the counter electrode 8 may be any direction. Further, a length direction of the slit may be different for each counter electrode 8. A shape of the counter electrode 8 may be any shape as long as it is possible to generate a fringe electric field between with the pixel electrode 6, such as a comb shape, for example.

Further, the present invention is not limited to the application to the TFT array substrate having a TFT, but can be widely applied to a TFT array substrate having a configuration in which a pixel electrode is directly overlapped and formed on the drain electrode of the TFT of each pixel. Furthermore, even in the FFS type TFT array substrate in which the drain electrode and the pixel electrode of the TFT are formed in different layers via the insulating film and the both are connected via a contact hole opened to the insulating film, the present embodiment can be applied.

Manufacturing Method

Next, a manufacturing method of a liquid crystal display apparatus, particularly a manufacturing method of a TFT array substrate will be described. FIGS. 7A and 7B to 18A and 18B are views showing a manufacturing process of the TFT array substrate. FIGS. 7A and 7B to 18A and 18B individually show a cross section of the TFT to pixel electrode part (cross section taken along line A1-A2 in FIG. 2) and a cross section of the source wiring/pixel electrode part in each process. In order to more clearly describe the features of the present invention, as a cross-sectional view of the source wiring/pixel electrode part, similarly to the description in the structure of the pixel, a cross-sectional view at a portion indicated by B1-B2 in FIG. 2 is shown.

First, a transparent insulating substrate 1 made of glass or the like is cleaned, and the entire surface of the substrate 1 is formed with a first metal film made of Cr, Ag, Ta, Ti, Mo, W, Ni, Cu, Au, or Ag, an alloy film mainly containing any of these, or a laminated film of any of these, for example, by a sputtering method, an evaporation method, or the like.

Next, a resist (not shown) is applied on the first metal film, and the resist is exposed from above a photomask to sensitize the resist. The sensitized resist is developed and patterned to form a resist pattern. Then, the first metal film is patterned by etching with this resist pattern as a mask, to form the gate wiring 43 (gate electrode) and the common wiring 43a, and then the resist pattern is removed. The structure at this point is shown in FIGS. 7A and 7B.

Hereinafter, a series of processes for forming the resist pattern in such a pattern forming process will be referred to as “photolithography process”, a process of patterning with use of the resist pattern is referred to as “etching process”, and a process of removing the resist pattern is referred to as “resist removal process”. Through a first photolithography process, a first etching process, and a first resist removal process that are described above, the gate wiring 43 (gate electrode) and the common wiring 43a that are made by the first metal film are formed on the substrate 1 as shown in FIGS. 7A and 7B.

Next, a first insulating film to be the gate insulating film 11, the semiconductor film 2, and the ohmic contact film 3 are formed in this order so as to cover the gate wiring 43 and the common wiring 43a. These are formed on the entire surface of the substrate 1 by plasma chemical vapor deposition (CVD), atmospheric pressure CVD, reduced pressure CVD, or the like.

As the gate insulating film 11, silicon nitride, silicon oxide, or the like can be used. In order to inhibit a short circuit due to an occurrence of a film defect such as a pinhole, formation of the gate insulating film 11 is desirably divided into a plurality of times. As the semiconductor film 2, amorphous silicon, polycrystalline silicon, or the like can be used. Further, as the ohmic contact film 3, n-type amorphous silicon or n-type polycrystalline silicon added with an impurity such as phosphorus (P) at high concentration can be used. As the semiconductor film 2, an oxide semiconductor film such as In—Ga—Zn—O or the like may be formed by a sputtering method. In this case, the ohmic contact film may be unnecessary.

In addition, the ohmic contact film 3 is formed thereon with a second metal film of Cr, Ag, Ta, Ti, Mo, W, Ni, Cu, Au, or Ag, an alloy film mainly containing any of these, or a laminated film made of any of these, for example, by a sputtering method, an evaporation method, or the like.

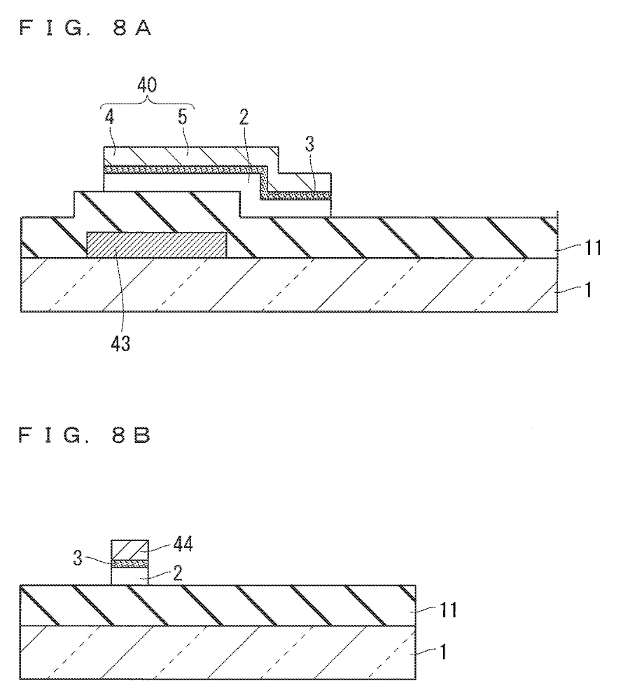

Next, a resist pattern is formed by a second photolithography process, and the second metal film, the ohmic contact film 3, and the semiconductor film 2 are sequentially etched by a second etching process with the resist pattern as a mask. The structure at this point is shown in FIGS. 8A and 8B.

In this second etching process, the second metal film is patterned into a shape formed of the source wiring 44 and a metal film 40 branched from the source wiring 44 and extending to a formation area of the TFT 50. The metal film 40 branched from the source wiring 44 is divided into two in a later process to become the source electrode 4 and the drain electrode 5, That is, at this point of time, the second metal film (metal film 40) remains at a portion to be the channel region 51 of the TFT 50, and the source electrode 4 and the drain electrode 5 are connected. That is, in the second etching process, the source electrode 4 and the drain electrode 5 in a state of being connected to each other are formed, and the source wiring 44 connected to the source electrode 4 is formed.

In addition, the ohmic contact film 3 and the semiconductor film 2 are also etched with use of the same mask as that of the patterning of the second metal film (substantially, the patterned second metal film serves as a mask). This allows the ohmic contact film 3 and the semiconductor film 2 to be patterned into the same shape as the second metal film.

In this manner, since the same mask is used for patterning of the second metal film and for patterning of the ohmic contact film 3 and the semiconductor film 2, the patterning of these can be integrated into one etching process (second etching process). Thereafter, a second resist removal process of removing the resist pattern formed in the second photolithography process is performed.

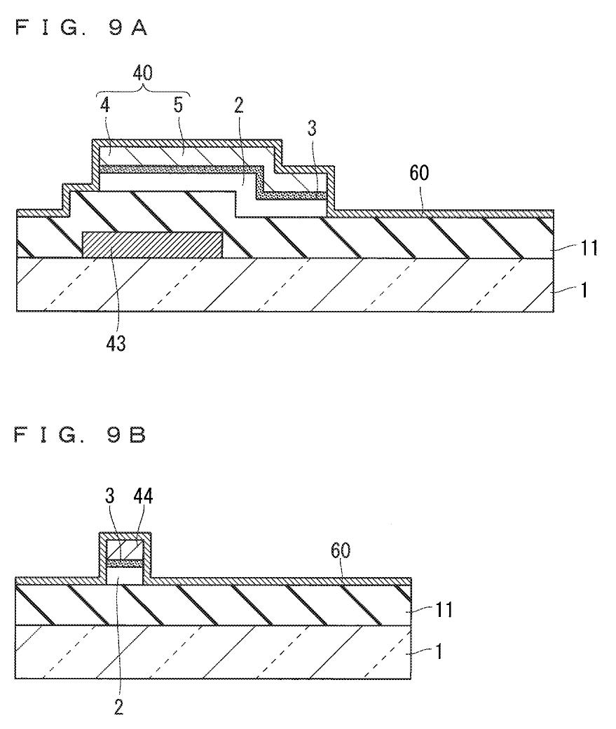

Next, a first transparent conductive film 60 to be the pixel electrode 6 is formed on the entire surface of the substrate 1 by a sputtering method or the like. The structure at this point is shown in FIGS. 9A and 9B. As the first transparent conductive film 60, ITO or the like can be used.

Then, by a third photolithography process, resist film (not shown) covers the first transparent conductive film 60 so as to form the first transparent conductive film pattern 6a and the pixel electrode 6, and the pattern is formed by a third etching process.

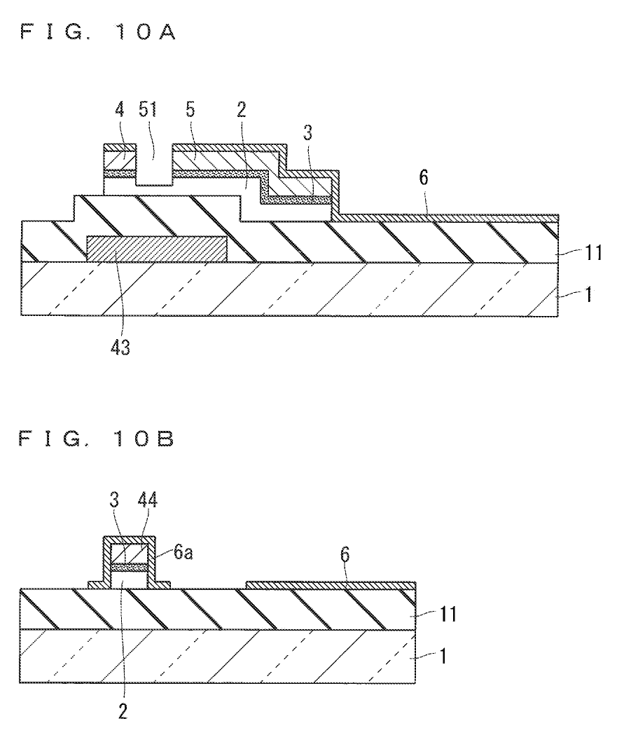

Moreover, in the third etching process, after etching away of the first transparent conductive film 60 and the second metal film 40 that are not covered with the above resist film, the ohmic contact film 3 exposed in the channel region 51 is also removed. Although not shown, a surface of the semiconductor film 2 is often slightly etched away in practice because the ohmic contact film 3 may cause failure of a bright spot defect when partially remaining. The structure at this point is shown in FIGS. 10A and 10B.

In the above description, there has been described that the resist pattern formed in the third photolithography process serves as an etching mask in etching of the first transparent conductive film 60, the second metal film 40, the ohmic contact film 3, and the semiconductor film 2 in the third etching process. However, etching of the second metal film 40, the ohmic contact film 3, and the semiconductor film 2 may be performed with, as a mask, the first transparent conductive film pattern 6a (including the pixel electrode 6) after the patterning and in a state where the above resist pattern is removed. Thereafter, by a third resist removal process, the resist pattern formed by the fourth photolithography process is removed.

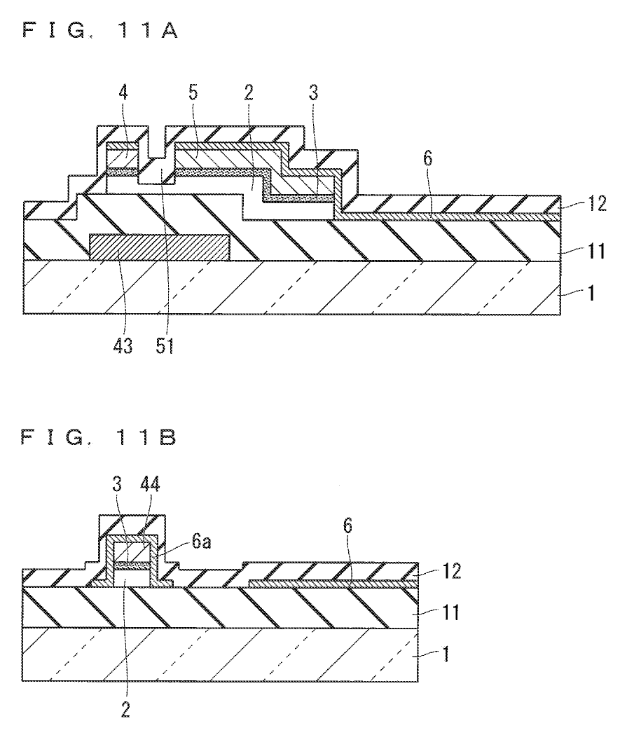

Subsequently, a second insulating film to be the interlayer insulating film 12 is formed. The structure at this point is shown in FIGS. 11A and 11B. For the interlayer insulating film 12, for example, an inorganic insulating film such as silicon nitride, silicon oxide, or the like is formed over the entire surface of the substrate 1 by CVD method, spin-on glass (SOG), or the like. This allows the pixel electrode 6 and the first transparent conductive film pattern 6a to be covered with the interlayer insulating film 12. In addition, the channel region 51 of the semiconductor film 2 is covered with the interlayer insulating film 12.

Next, by a fourth photolithography process and a fourth etching process, the contact hole 13 passing through the interlayer insulating film 12 and the gate insulating film 11 is formed. As shown in FIG. 6, the contact hole 13 is formed so as to reach the common wiring 43a.

Although not shown, the frame area 42 is formed with a terminal (gate terminal) for connection of the gate wiring 43 to the scanning signal driving circuit 45 and a terminal (source terminal) for connection of the source wiring 44 to the display signal driving circuit 46, with used of a wiring layer (first metal film) in the same layer as the gate wiring 43 or a wiring layer (second metal film) in the same layer as the source wiring 44. In the fourth photolithography process and the fourth etching process, a contact hole reaching the above terminals is also formed.

Thereafter, by a fourth resist removal process, the resist pattern formed by the fourth photolithography process is removed.

Next, on the interlayer insulating film 12, a second transparent conductive film 80 to be the counter electrode 8 is formed on the entire surface of the substrate 1 by a sputtering method or the like.

As the second transparent conductive film 80, an amorphous transparent conductive film such as an amorphous ITO (a-ITO) film or the like can be used. In the first preferred embodiment, as will be described later, heat is applied to the a-ITO film to form a film (etching inhibition layer) that is not to be etched. Accordingly, it is assumed that the formed film is a transparent conductive film and has a property to be subjected to heat treatment after the etching process.

Then, in the second pixel, as will be described later, the second transparent conductive film is patterned by a fifth photolithography process, to form the counter electrode 8 having the slit 8a as shown in FIGS. 3 and 5A and 5B. Whereas, the first pixel is, as will be described later, formed with the counter electrode 8 having no slit 8a, as shown in FIGS. 2 and 4A and 4B. Further, as shown in FIG. 6, the counter electrode 8 is also formed inside the contact hole 13 so as to be in contact with the common wiring 43a.

At this time, although not shown in the frame area 42, there are formed a pad (gate terminal pad) connected to the gate terminal via a contact hole, and a pad (source terminal pad) connected to the source terminal via a contact hole.

As described above, the present embodiment has the feature that no slit is provided in the counter electrode of the first pixel alone in which a bright spot defect is to occur. Hereinafter, a manufacturing method of the counter electrode 8 will be described while contrasting the first pixel and the second pixel.

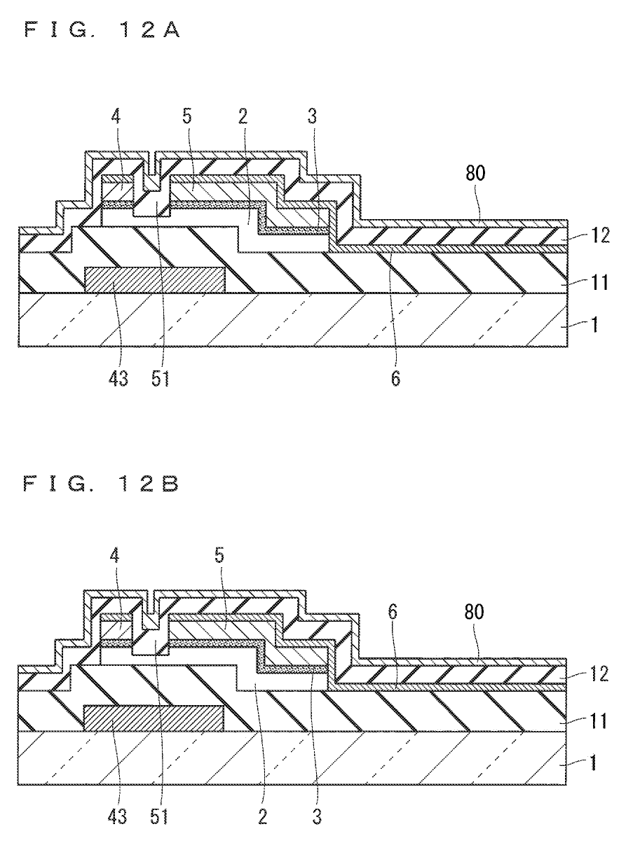

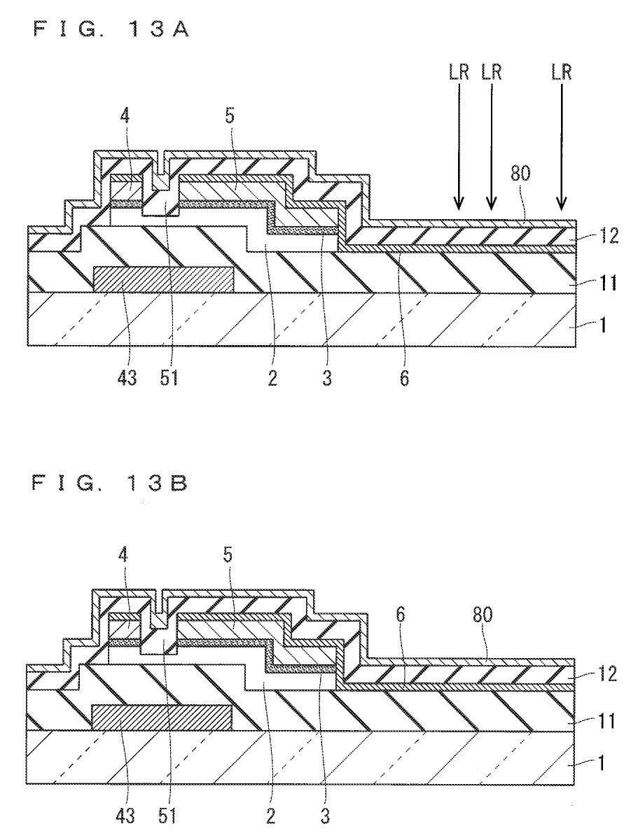

The patterning method of the counter electrode will be described below with reference to cross-sectional views. FIGS. 12A and 12B are cross-sectional views of the TFT to pixel electrode part in the first pixel and the second pixel, respectively. This similarly applies to FIGS. 13A and 13B and the subsequent figures. Note that the cross-sectional view of the TFT to pixel electrode part corresponds to the cross section taken along line A1-A2 in FIG. 2 or FIG. 3. Further, FIG. 12A corresponds to the first pixel, and FIG. 12B corresponds to the second pixel. This similarly applies to FIGS. 13A and 13B and the subsequent figures.

FIGS. 12A and 12B show a state where, the second transparent conductive film 80 to be the counter electrode 8 on the interlayer insulating film 12 is formed on the entire surface of the substrate 1 by a sputtering method or the like. At this point of time, both figures are in a same state.

Next, laser light irradiation LR is performed on the second transparent conductive film 80 in the first pixel that has been specified, as a pixel in which a bright spot defect is to occur, in advance by an optical defect inspection apparatus or the like. This state is shown in FIG. 13A. Whereas, since the second pixel corresponding to FIG. 13B is not irradiated with laser light, FIG. 13B does not change from FIG. 12B. Note that a method of specifying a pixel in which a bright spot defect is to occur will be described later by giving a representative defect failure mode.

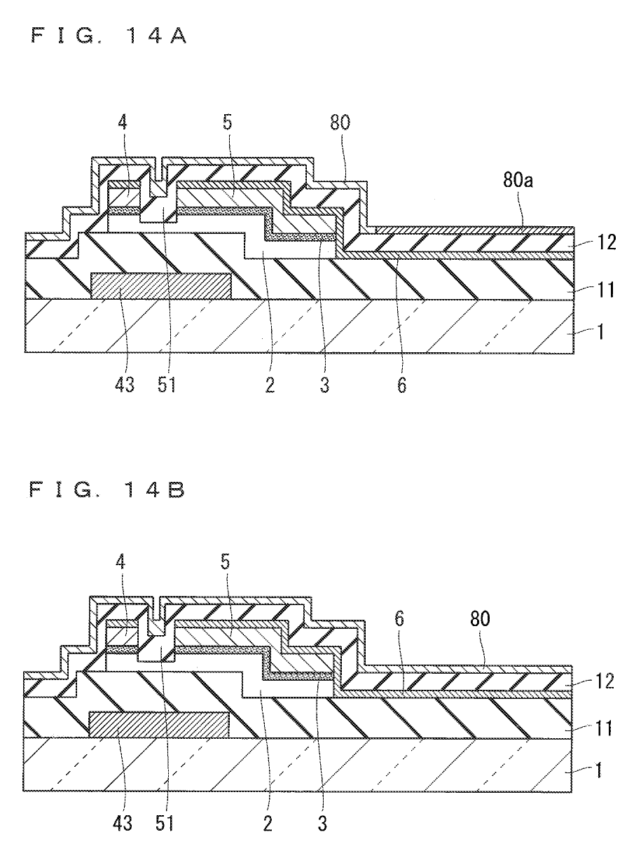

This laser light irradiation changes a part of the second transparent conductive film 80 in the first pixel into a crystallized transparent conductive film 80a. This state is shown in FIG. 14A. Whereas, since the second pixel corresponding to FIG. 14B is not irradiated with laser light, FIG. 14B does not change from FIG. 12B.

Here, a region irradiated with the laser light may be the entire first pixel, but may be merely a region overlapping with the pixel electrode 6. This is because the generation of the fringe electric field can still be sufficiently suppressed.

A wavelength at which the transparent conductive film does not transmit light is suitable for the wavelength of the laser light, and the wavelength may be, for example, 266 nm. Too strong power of the laser light may break the second transparent conductive film 80, while too weak power is not able to sufficiently crystallize the second transparent conductive film 80, on the contrary. Therefore, appropriate adjustment is necessary.

For a laser light irradiation apparatus, for example, a laser light of a CVD repair laser apparatus may be used. Other apparatuses can also perform such a process as long as the apparatus can locally apply heat treatment to the first pixel alone.

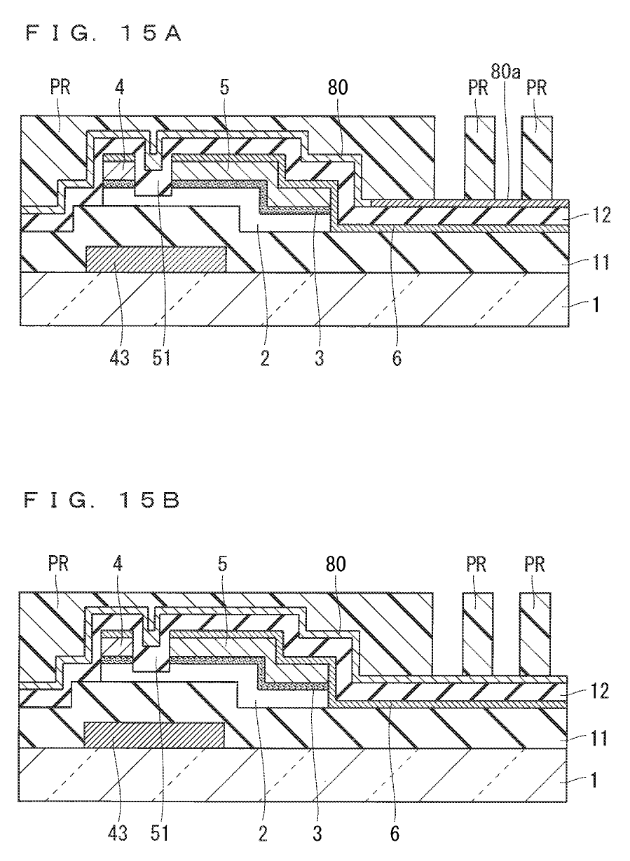

Next, as shown in FIGS. 15A and 15B, a resist pattern PR is formed by the fifth photolithography process. This process is for forming the counter electrode 8 and the slit 8a by subsequent etching, but the process is similarly performed not only for the second pixel but also for the first pixel.

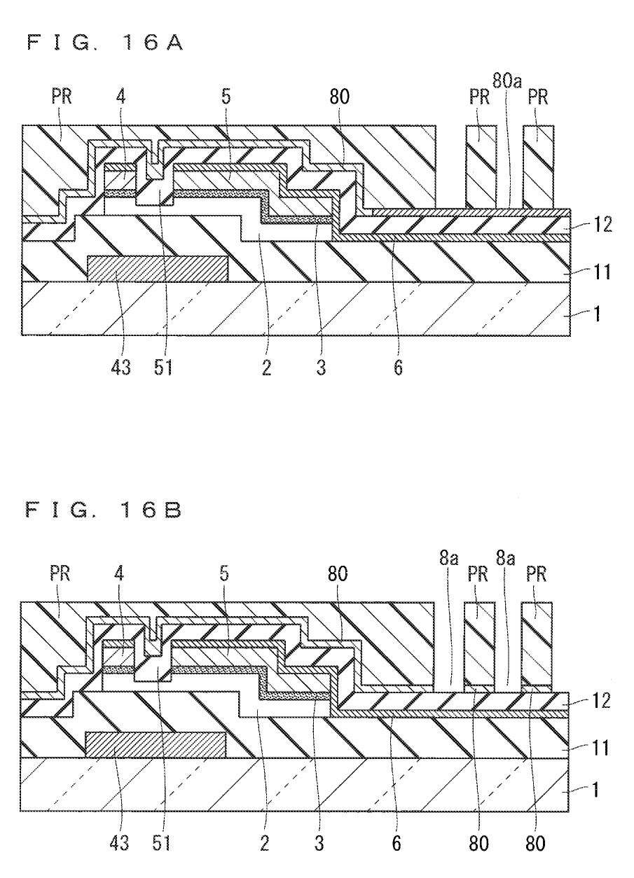

Next, FIGS. 16A and 16B show cross-sectional views of a state where a fifth etching is performed. In this etching process, there is used an etching solution (etchant), such as oxalic acid, having a remarkably high etching rate of an amorphous transparent conductive film as compared with a crystallized transparent conductive film.

By using such an etching solution, while the second transparent conductive film 80 exposed at the counter electrode 8 of the second pixel is selectively etched away, the crystallized transparent conductive film 80a in the first pixel irradiated with the laser light is not etched away. That is, as shown in FIGS. 2 and 4A and 4B, the first pixel is formed with the counter electrode 8 without a slit.

Whereas, the second pixel is formed with the counter electrode 8 having the slit 8a, as shown in FIGS. 3 and 5A and 5B. Such a difference can also be said to be caused by the fact that the second transparent conductive film 80 in the first pixel has been changed to an etching inhibition layer, which is the crystallized transparent conductive film 80a.

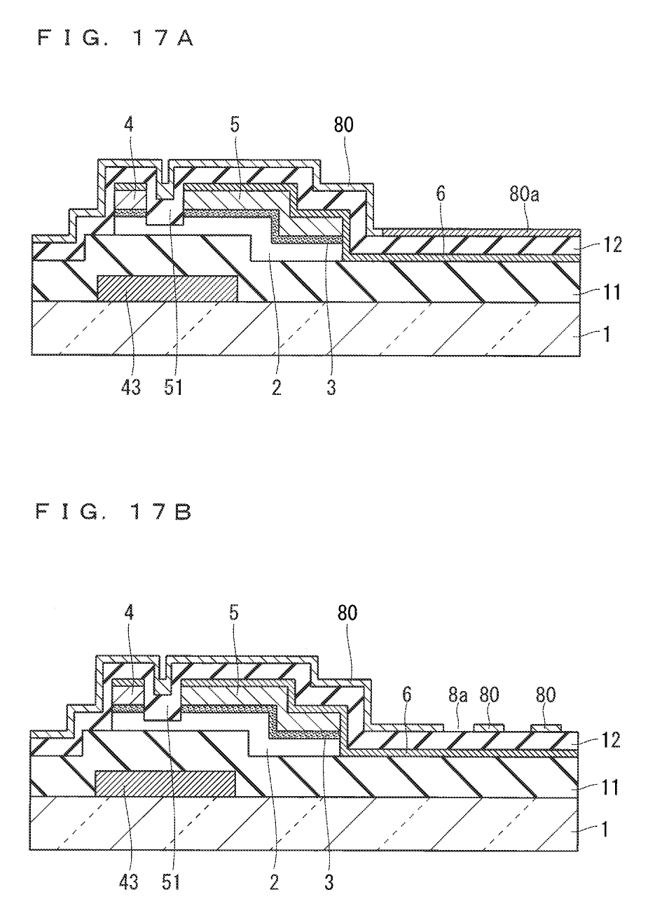

Then, the resist pattern PR is removed. This state is shown in FIGS. 17A and 17B. In this state, the second transparent conductive film in the first pixel is crystallized, but the second transparent conductive film in the second pixel not irradiated with laser light remains amorphous.

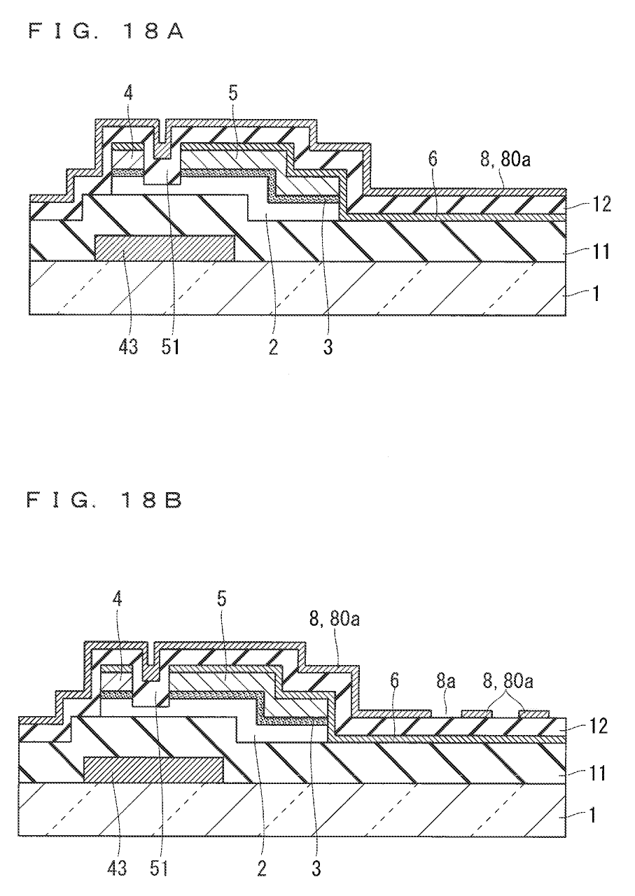

In the subsequent process, the amorphous film described above may be crystallized by applying a heat treatment to the entire surface of the substrate with an annealing apparatus or the like. That is, all of the second transparent conductive film 80 formed on the array substrate may be changed to the crystallized transparent conductive film 80a. This state is shown in FIGS. 18A and 18B.

(Modification)

In the manufacturing method according to the present embodiment, the manufacturing method has been described in which laser light is irradiated after the formation of the second transparent conductive film 80 (shown in FIGS. 12A and 12B). The process of irradiating laser light may be after formation of the resist pattern in the fifth photolithography process (shown in FIGS. 15A and 15B). Hereinafter, this manufacturing method will also be described with reference to cross-sectional views of the TFT to pixel electrode part.

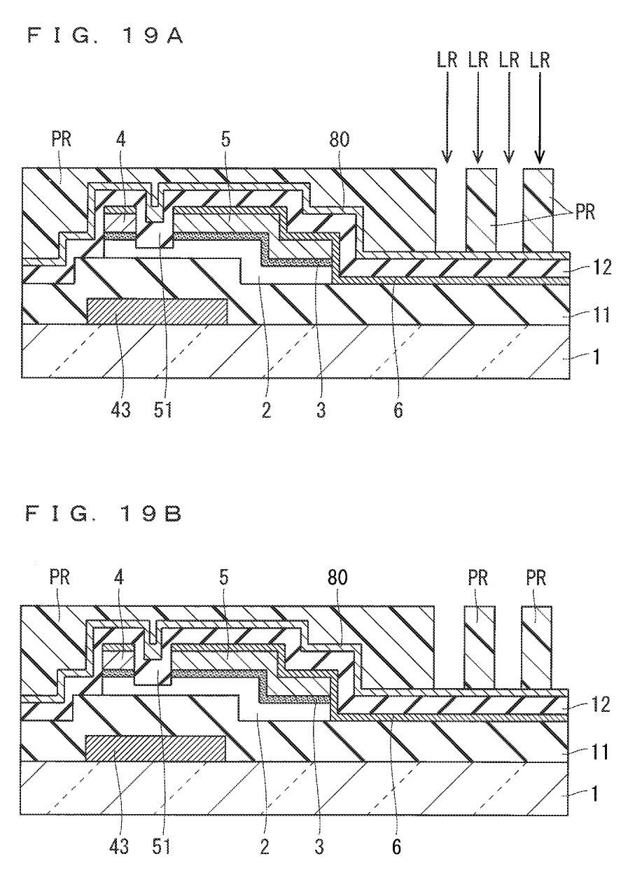

FIGS. 19A and 19B are cross-sectional views of the source wiring/pixel electrode part in the first pixel and the second pixel, respectively. Both figures show a state where laser light irradiation LR is performed after the fifth photolithography process. Before the laser light irradiation, the second transparent conductive film 80 in the first pixel remains amorphous.

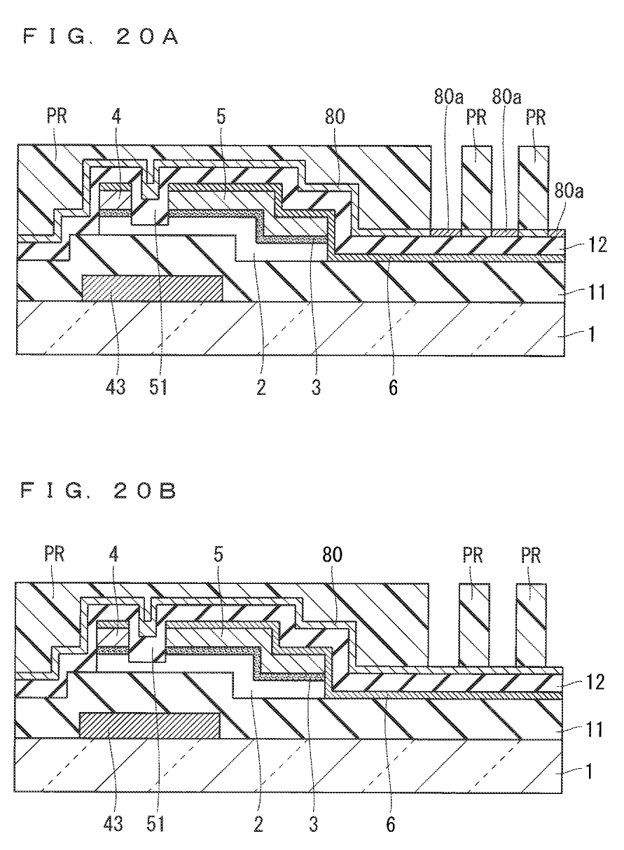

This laser light irradiation changes the second transparent conductive film 80 in the first pixel into the crystallized transparent conductive film 80a, in a region not covered with a resist PR. This state is shown in FIG. 20A. Whereas, since the second pixel corresponding to FIG. 20B is not irradiated with laser light, FIG. 20B does not change from FIG. 19B.

Selection of a wavelength and power of the laser light is as described in the first preferred embodiment, but it is also necessary to consider not to cause damage to the resist PR in this modification.

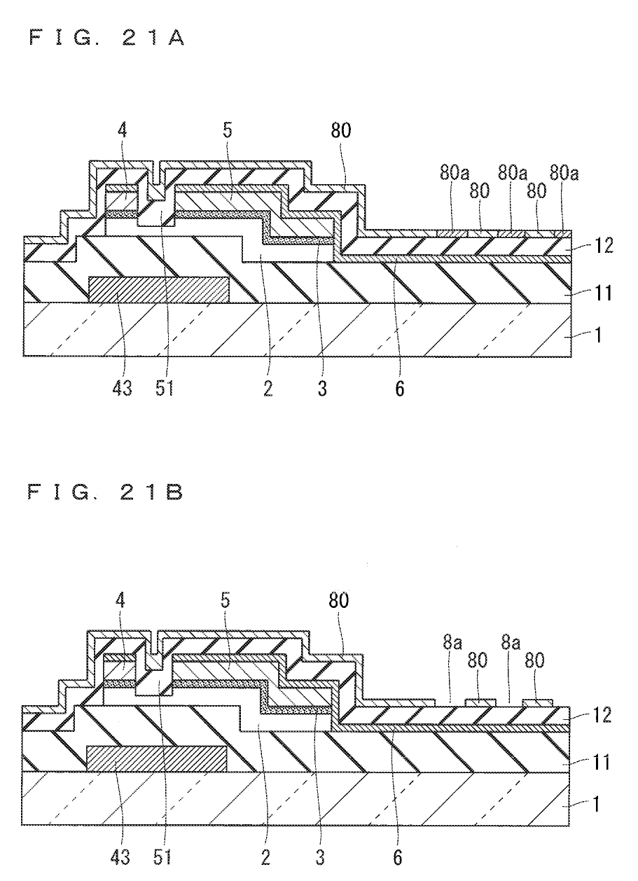

Next, FIGS. 21A and 21B show cross-sectional views of a state where the fifth etching is performed to remove the resist PR. In this etching process as well, there is used an etching solution (etchant), such as oxalic acid, having a remarkably high etching rate of an amorphous transparent conductive film as compared with a crystallized transparent conductive film.

By using such an etching solution, while the second transparent conductive film 80 exposed at the counter electrode 8 of the second pixel is selectively etched away, the crystallized transparent conductive film 80a in the first pixel irradiated with the laser light is not etched away. That is, as shown in FIGS. 2 and 4A and 4B, the first pixel is formed with the counter electrode 8 without a slit. Whereas, the second pixel is formed with the counter electrode 8 having the slit 8a.

Processes in and after FIGS. 21A and 21B are similar to those in the first preferred embodiment. In the counter electrode 8 in the first pixel shown in FIG. 21A, there is formed the crystallized transparent conductive film 80a, exclusively at a slit part expected to be formed originally, but the display characteristics of the liquid crystal display apparatus is not affected. In addition, a state as shown in FIGS. 18A and 18B is obtained when all of the second transparent conductive film 80 formed on the array substrate is changed to the crystallized transparent conductive film 80a by applying a heat treatment to the entire surface of the substrate with an annealing apparatus or the like.

Through the above processes, the TFT array substrate is completed. In this manner, an array substrate to be applied to an FFS mode liquid crystal display apparatus is obtained through at least five times of photolithography process.

On the TFT array substrate produced in this way, an alignment film is formed in a subsequent cell process. Further, an alignment film is also formed similarly on a separately produced counter substrate. Then, an alignment treatment for causing micro scratches in one direction is applied to a contact surface of each alignment film with the liquid crystal by using a method such as rubbing. Thereafter, a sealing material is applied to a substrate periphery, and the TFT array substrate and the counter substrate are bonded at a predetermined interval such that the alignment films of the both are facing each other. After bonding the TFT array substrate and the counter substrate, liquid crystal is injected between the TFT array substrate and the counter substrate by a vacuum injection method or the like, and the injection port is sealed. Thereby, the liquid crystal cell is completed.

Then, the polarizing plates are attached to both sides of the liquid crystal cell, the driving circuit is connected, and then the backlight unit is attached, whereby the liquid crystal display apparatus is completed.

Further, in this first preferred embodiment, a description has been given to a manufacturing method not including the photolithography process between the formation of the semiconductor film and the formation of the second metal film, but the photolithography process may be included. That is, although the total number of photolithography processes is increased by one process, the manufacturing method may be adapted to form the second metal film after patterning the semiconductor film or the ohmic contact film.

### Second Preferred Embodiment

In the first preferred embodiment, the manufacturing method has been described in which an etching inhibition layer that is not etched in the subsequent etching process is formed by crystallizing the transparent conductive film constituting the common electrode in the pixel determined that a bright spot defect is to occur. However, among the transparent conductive films, there is a material that is difficult to crystallize, such as indium zinc oxide (IZO).

Since a residue of the IZO film is small when being etched, there is an advantage of being able to inhibit cloudiness caused when the insulating film is formed on the residue. However, since IZO is a material that is difficult to crystallize, application to the manufacturing method according to the first preferred embodiment is not optimal. This second preferred embodiment has the feature that an etching inhibition layer is formed by newly forming a film, and a similar effect is exerted even with a transparent conductive film that is difficult to crystallize.

Since processes up to a process of forming a second insulating film to be an interlayer insulating film 12 and forming a contact hole 13 by a fourth photolithography process are the same as those in the manufacturing method according to the first preferred embodiment, the description will be omitted. Hereinafter, description will be made with reference to cross-sectional views.

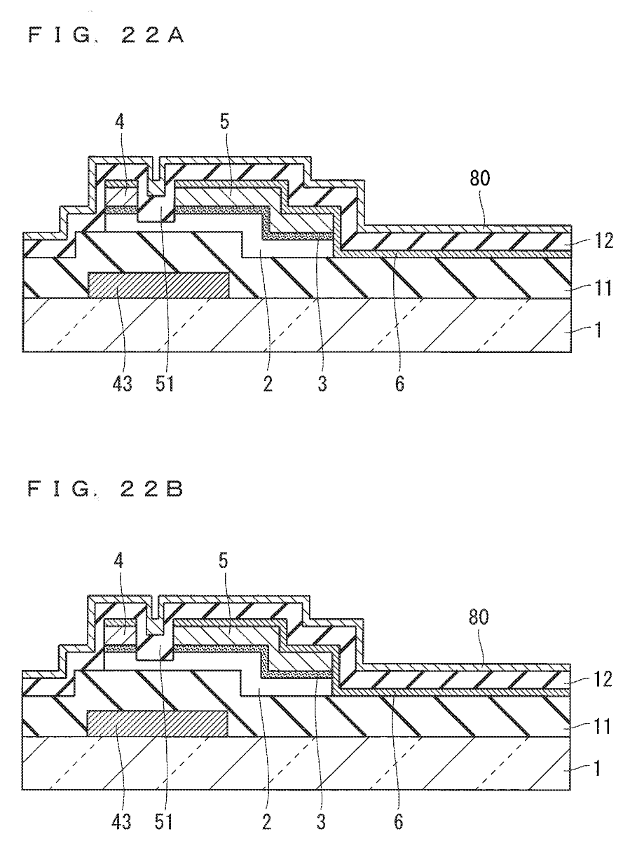

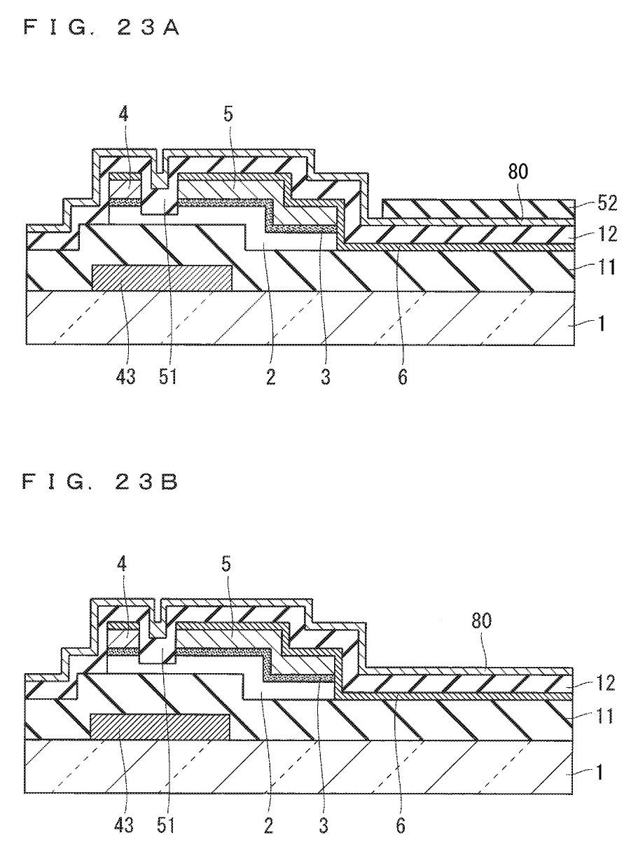

FIGS. 22A and 22B are cross-sectional views of a TFT to pixel electrode part in a first pixel and a second pixel, respectively. This similarly applies to FIGS. 23A and 23B and the subsequent figures. Note that the cross-sectional view of the TFT to pixel electrode part corresponds to the cross section taken along line A1-A2 in FIG. 2 or FIG. 3. Further, FIG. 22A corresponds to the first pixel, and FIG. 22B corresponds to the second pixel. This similarly applies to FIGS. 23A and 23B and the subsequent figures.

In FIGS. 22A and 22B, the second transparent conductive film 80 to be a counter electrode 8 on the interlayer insulating film 12 is formed on the entire surface of a substrate 1 by a sputtering method or the like. This state is shown in FIGS. 22A and 22B. A material of the second transparent conductive film 80 may be a material that is difficult to crystallize as described in the first preferred embodiment, for example, may be IZO.

In FIG. 23A, a film to be an etching inhibition layer 52 is deposited on the first pixel that has been specified, as a pixel in which a bright spot defect is to occur, in advance by an optical defect inspection apparatus or the like. For example, an insulating film may be used. The insulating film may be an opaque film without being limited to the transparent film normally used in the pixel 47. Further, the conductive film may be used without limiting to the insulating film. That is, it is significant that the inhibiting layer is for inhibiting removal of the second transparent conductive film 80 due to the etching process described later. Whereas, the second pixel is not provided with such an etching inhibition layer, as shown in FIG. 23B.

Here, a region formed with the etching inhibition layer 52 may be the entire first pixel, but may be merely a region overlapping with the pixel electrode 6. This is because the generation of the fringe electric field can still be sufficiently suppressed. Further, as an apparatus to locally form the etching inhibition layer in the first pixel alone, an atmospheric pressure plasma CVD apparatus or the like may be used.

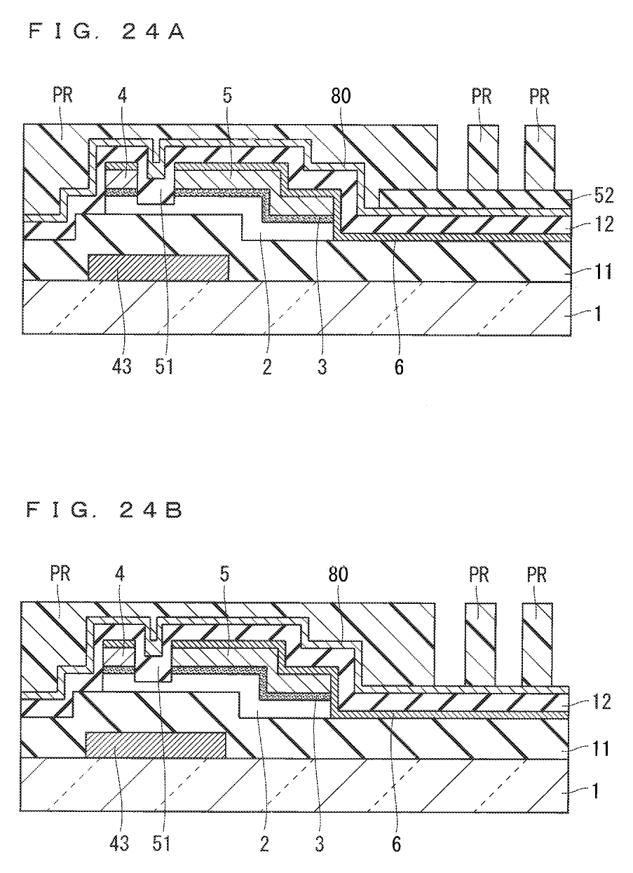

Next, as shown in FIGS. 24A and 24B, a resist pattern PR is formed by a fifth photolithography process. This process is for forming the counter electrode 8 and a slit 8a by subsequent etching, but the process is performed not only for the second pixel but also for the first pixel.

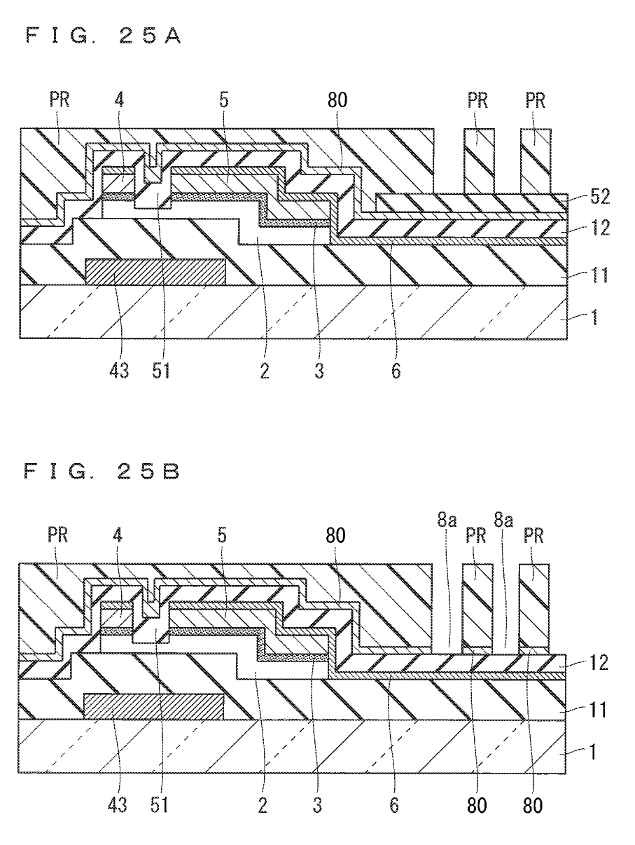

Next, FIGS. 25A and 25B show cross-sectional views of a state where a fifth etching is performed. In this fifth etching process, there is used an etching solution (etchant) having a remarkably high etching rate of the second transparent conductive film 80 as compared with the etching inhibition layer 52. For example, in a case where the etching inhibition layer 52 is an insulator such as silicon oxide, silicon nitride, or the like, aqua regia or the like may be used as the etching solution other than oxalic acid.

By using such an etching solution, while the second transparent conductive film 80 exposed at the counter electrode 8 of the second pixel is selectively etched away, the second transparent conductive film 80 covered with the etching inhibition layer 52 in the first pixel is not etched away. That is, as shown in FIGS. 2 and 4A and 4B, the first pixel is formed with the counter electrode 8 without a slit.

Whereas, the second pixel is formed with the counter electrode 8 having the slit 8a, as shown in FIGS. 3 and 5A and 5B. Such a difference can also be said to be caused by forming the etching inhibition layer 52 in the first pixel.

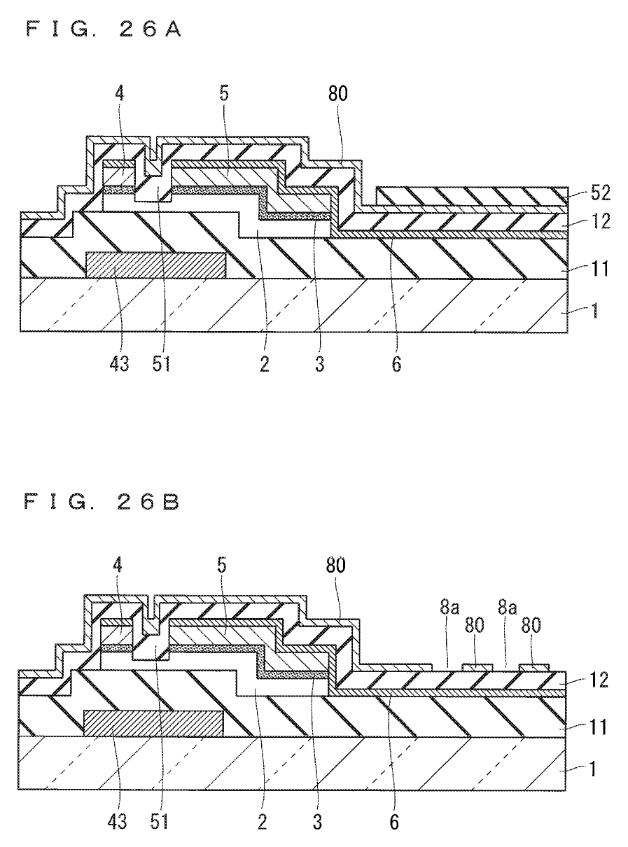

Then, the resist pattern PR is removed. This state is shown in FIGS. 26A and 26B. As described above, in the second preferred embodiment, it is possible to manufacture a structure in which no slit is formed in the counter electrode of the first pixel alone specified as a pixel in which a bright spot defect is to occur, even in a case where a material that is difficult to crystallize is used as the second transparent conductive film. This makes it possible to repair a bright spot defect to a black spot defect.

In a case where an amorphous ITO film is used as the second transparent conductive film, the amorphous film may be crystallized by applying a heat treatment to the entire surface of the substrate with an annealing apparatus or the like in the subsequent process. That is, all of the second transparent conductive film 80 formed on the array substrate may be crystallized.

Further, in a case where a material that does not transmit light is used as the etching inhibition layer 52, the etching inhibition layer 52 may be removed after the fifth etching or after removing the resist pattern.

### (Modification)

In the second preferred embodiment, the process of forming the etching inhibition layer is performed after the formation of the second transparent conductive film, but may be after forming the resist pattern PR in the fifth photolithography process (shown in FIGS. 24A and 24B). Hereinafter, this manufacturing method will also be described with reference to cross-sectional views of the TFT to pixel electrode part.

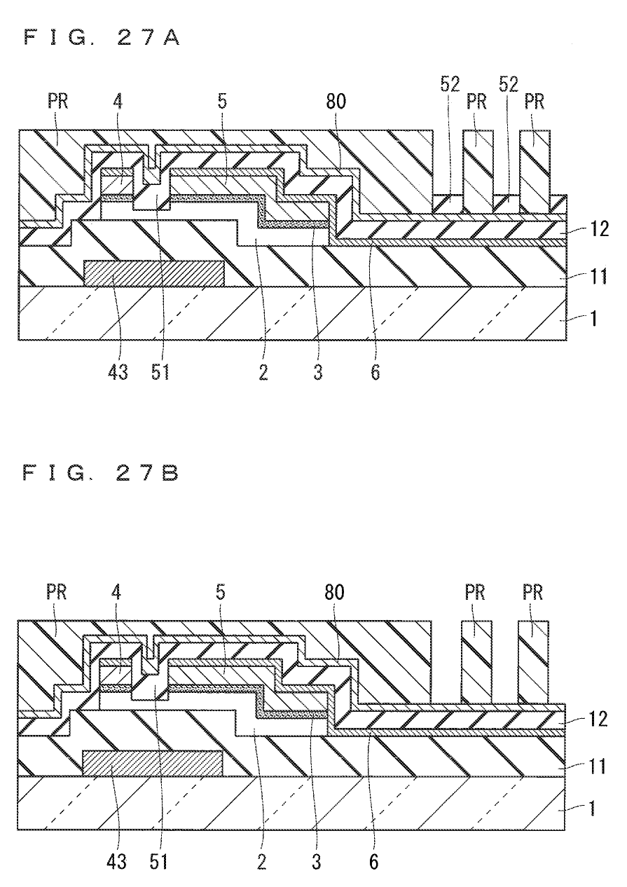

FIGS. 27A and 27B are cross-sectional views of the TFT to pixel electrode part in the first pixel and the second pixel, respectively. FIG. 27A corresponding to the first pixel shows a state where the etching inhibition layer 52 is formed after the fifth photolithography process. Whereas, such an inhibition layer is not formed in FIG. 27B corresponding to the second pixel. Note that, in forming the etching inhibition layer 52, it is necessary to consider not to give physical or chemical damage or alteration to the resist pattern PR.

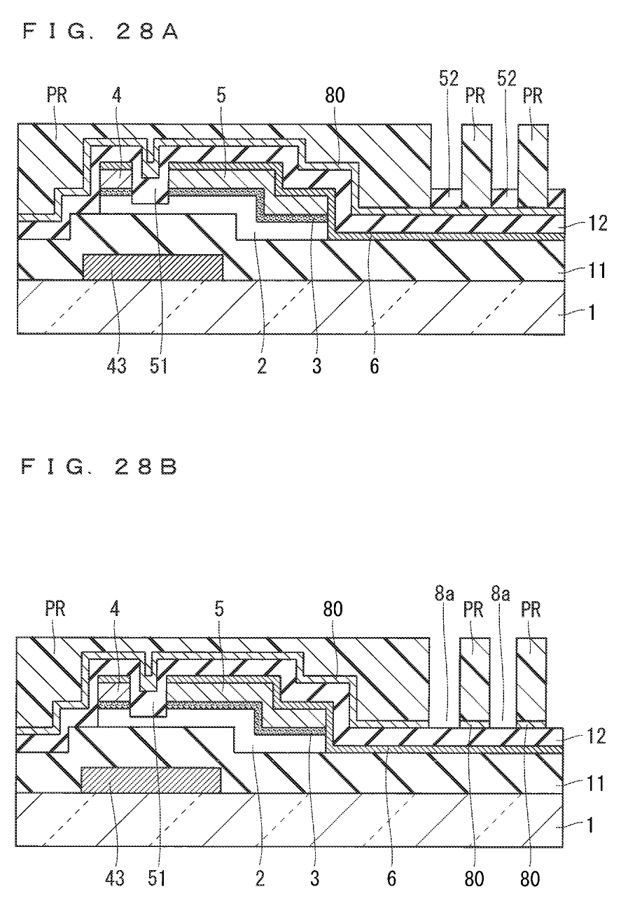

Next, FIGS. 28A and 28B show cross-sectional views of a state where etching is performed. In this fifth etching process as well, it is desirable to use an etching solution (etchant) having a remarkably high etching rate of the second transparent conductive film 80 as compared with the etching inhibition layer 52.

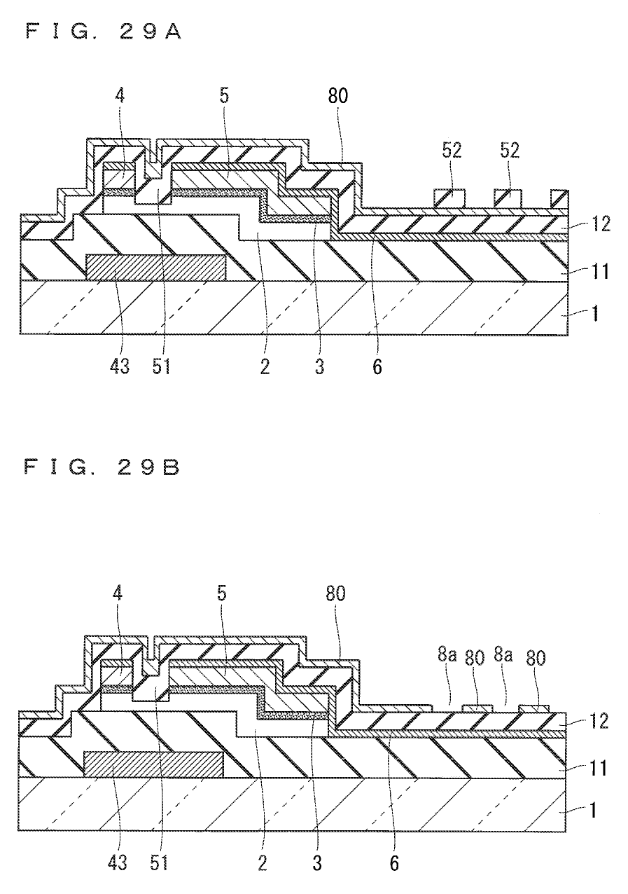

By using such an etching solution, while the second transparent conductive film 80 exposed at the counter electrode 8 of the second pixel is selectively etched away, the transparent conductive film 80a covered with the etching inhibition layer 52 in the first pixel is not etched away. That is, as shown in FIGS. 2 and 4A and 4B, the first pixel is formed with the counter electrode 8 without a slit. Whereas, the second pixel is formed with the counter electrode 8 having the slit 8a. Then, the resist pattern PR is removed. This state is shown in FIGS. 29A and 29B. Since this and subsequent states are similar to those in the second preferred embodiment, the description will be omitted.

In this modification as well, an effect similar to that in the second preferred embodiment can be achieved. In the present embodiment, an example of applying IZO that is difficult to crystallize is described as a material of the second transparent conductive film, but it is also possible to apply ITO that is easy to crystallize. ITZO may also be used.

### Third Preferred Embodiment

In the manufacturing methods according to the first and second preferred embodiments, a bright spot defect is repaired to a black spot defect by locally crystallizing the transparent conductive film constituting the counter electrode or forming a new film. A third preferred embodiment provides a manufacturing method that achieves a similar effect without adding such a new process.

For the photosensitive resist of the photolithography apparatus in the fifth photolithography process in the first and second preferred embodiments, the description is given to the manufacturing methods using a positive resist, in which the photosensitive resist is applied to the entire surface of the substrate, the photosensitive resist is exposed from above the photomask, and the sensitized resist part is removed with a developing solution and patterned, to form a resist pattern. Whereas, in a case where a negative resist is used instead of the positive resist, the manufacturing method is such that a resist pattern is formed by removing, with a developing solution, a resist part that has not been sensitized, but by leaving the sensitized resist part without being removed even if being exposed to a developing solution.

In the third preferred embodiment, a negative resist is applied in a fifth photolithography process, and after sensitizing the resist, a resist of a first pixel alone specified as a pixel in which a bright spot defect is to occur in advance is additionally sensitized. Hereinafter, description will be made with reference to cross-sectional views.

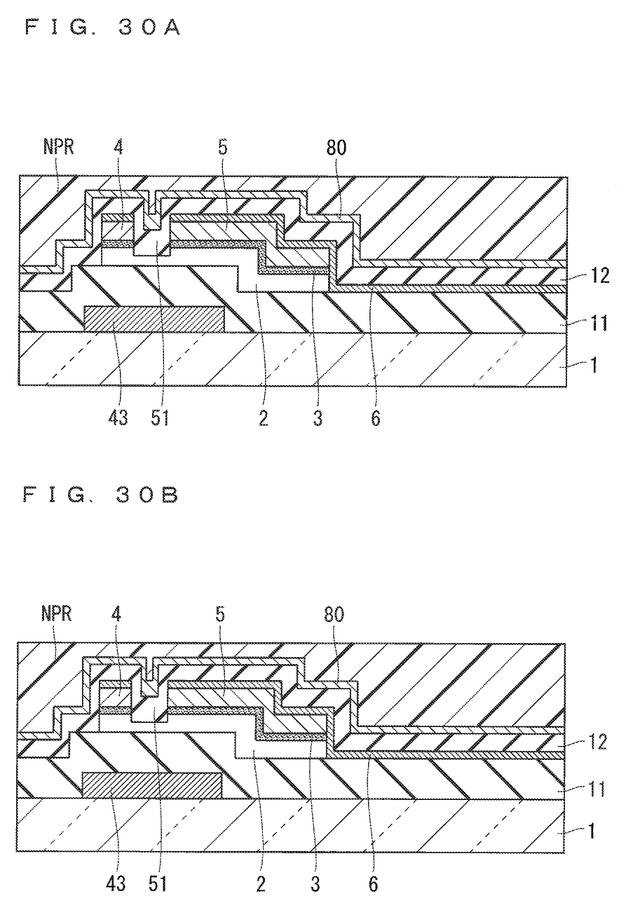

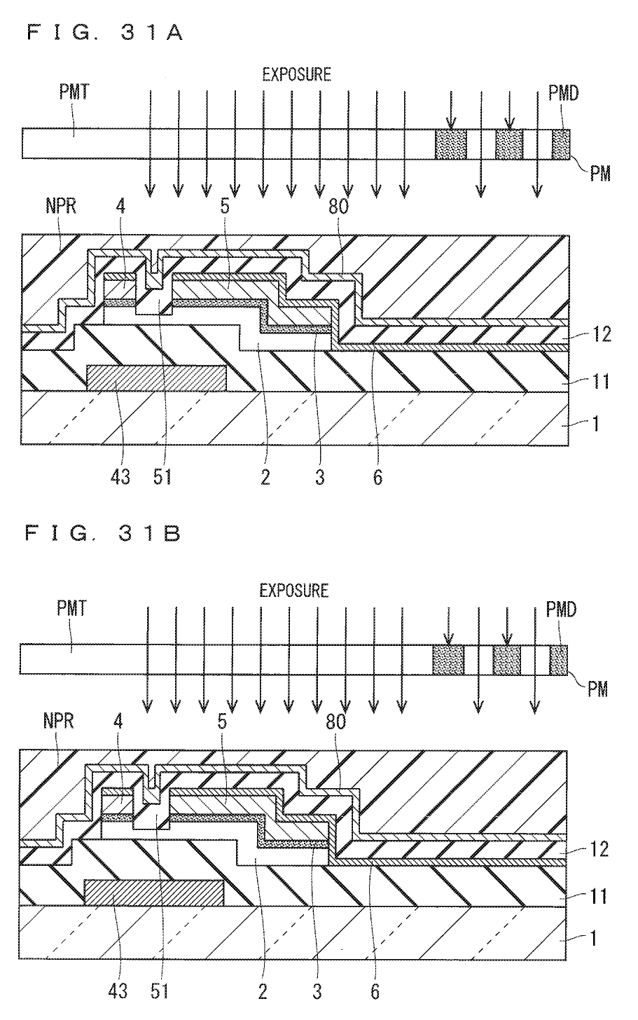

FIGS. 30A and 30B are cross-sectional views of a TFT to pixel electrode part in a first pixel and a second pixel, respectively. This similarly applies to FIGS. 31A and 31B and the subsequent figures. Note that the cross-sectional view of the TFT to pixel electrode part corresponds to the cross section taken along line A1-A2 in FIG. 2 or FIG. 3. Further, FIG. 30A corresponds to the first pixel, and FIG. 30B corresponds to the second pixel. FIGS. 31A and 31B and the subsequent figures have a similar correspondence.

FIGS. 30A and 30B are cross-sectional views showing a state where a negative photosensitive resist NPR for the fifth photolithography process is applied on the second transparent conductive film 80. In this state, FIGS. 30A and 30B are the same.

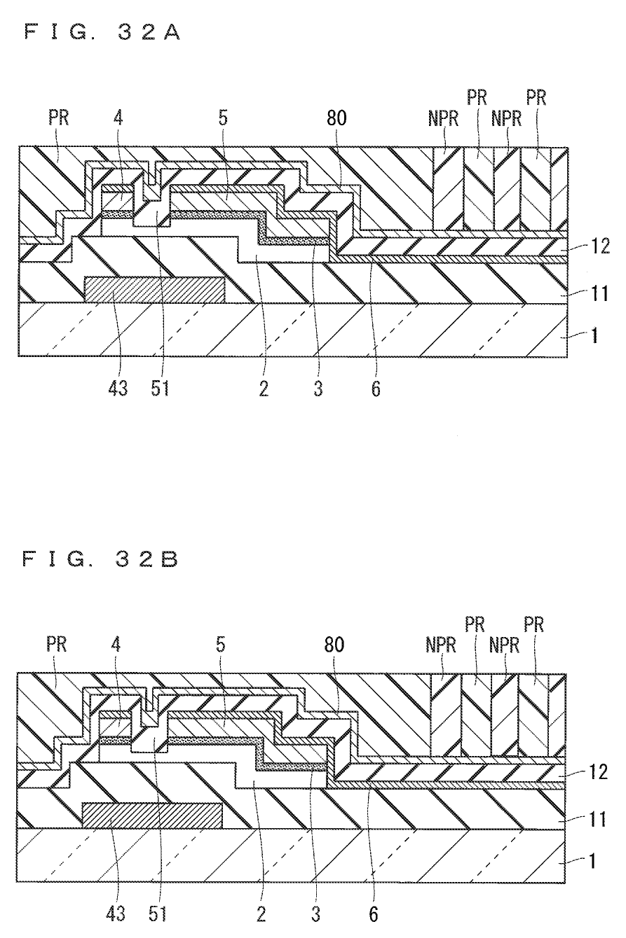

Next, as shown in FIGS. 31A and 31B, this photosensitive resist NPR is exposed by the fifth photolithography process. An exposure pattern mask PM1 at this time is for forming a slit 8a in a counter electrode 8, irrespective of the first pixel and the second pixel. Specifically, the exposure pattern mask PM1 is a mask in which a light-shielding part PMD is formed instead of a light-transmitting part PMT such that the exposure light is not irradiated to the negative resist NPR corresponding to a region formed with the slit 8a in the counter electrode 8. A state after exposure is shown in FIGS. 32A and 32B.

In FIGS. 32A and 32B, a resist PR is formed in a region where exposure is completed, and the resist NPR remains in a region not exposed. Here, the resist NPR is a resist before exposure, and the resist PR is also referred to as a resist after exposure. In this state as well, FIGS. 32A and 32B show a same state.

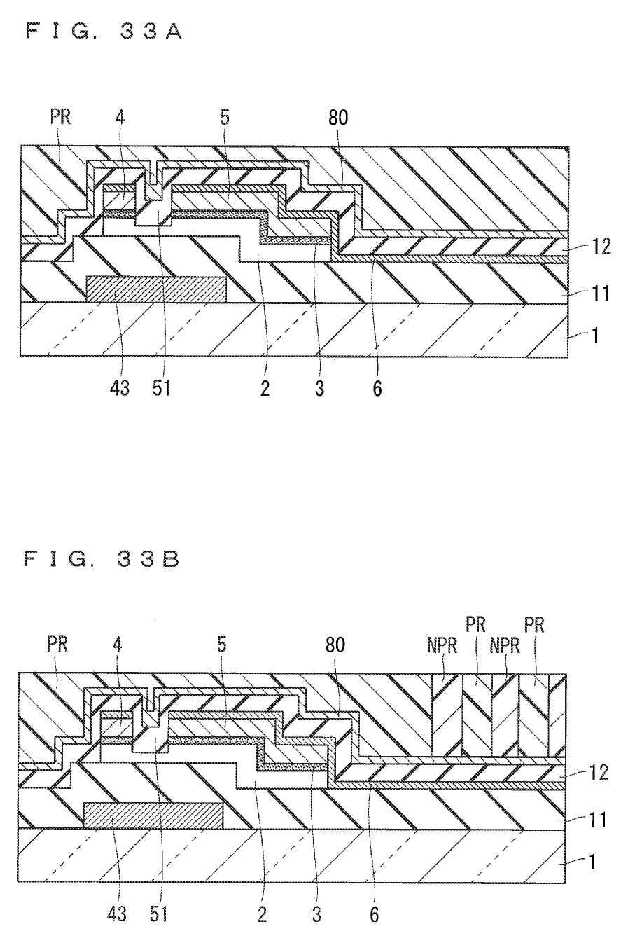

Next, exposure irradiation is additionally performed on the first pixel alone specified, as a pixel in which a bright spot defect is to occur, in advance by an optical defect inspection apparatus or the like. Here, a region irradiated with the exposure light may be the entire first pixel, but may be merely a region overlapping with the pixel electrode 6. This is because the generation of the fringe electric field can still be sufficiently suppressed. FIG. 33A shows a state after exposure. In FIG. 32A, the resist NPR and the resist PR are mixed, but in FIG. 33A, the resist NPR has changed to the resist PR by the additional exposure. Note that FIG. 33B is a view for comparison and is the same as FIG. 32B.

In a case of thus performing additional exposure on the resist of the first pixel alone, it is necessary to fetch, in an exposure apparatus, position information on the pixel that has been specified, as a pixel in which a bright spot defect is to occur, in advance by an optical defect inspection apparatus or the like. Moreover, an apparatus that can locally perform exposure in accordance with the position information is desirable. For example, there may be used an exposure apparatus of a direct drawing system or an exposure apparatus having an exposure function of a direct drawing system. It is also possible to use an apparatus that can incorporate an optical defect inspection apparatus into the exposure apparatus, to be able to successively perform additional exposure after detecting the first pixel to cause a bright spot defect.

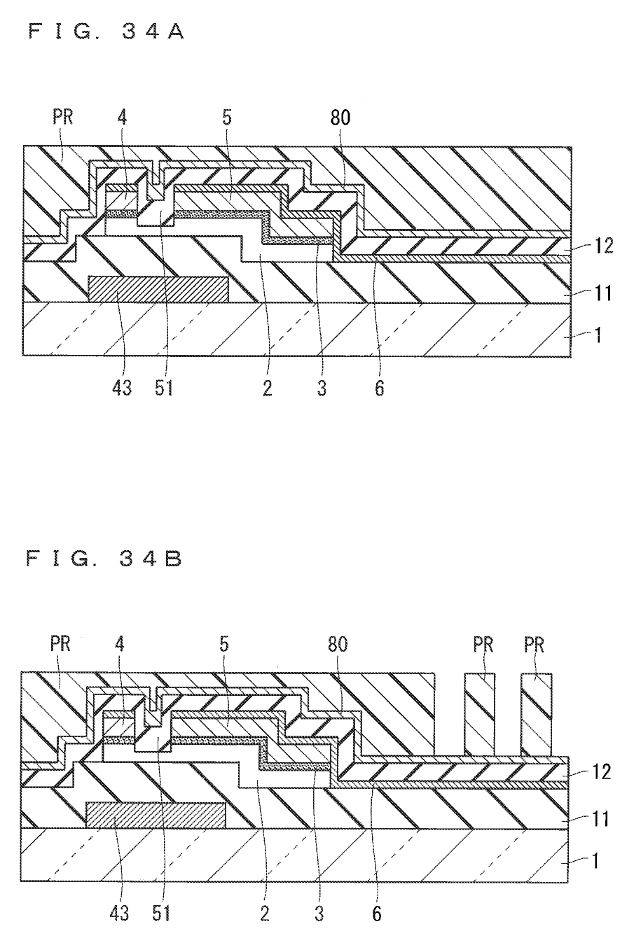

Next, development is performed. In the negative photosensitive resist, the resist PR as the exposed resist remains, and the resist NPR as the unexposed resist is removed. FIGS. 34A and 34B show a state after development. In FIG. 34A showing the first pixel, the resist PR remains so as to cover the pixel electrode 6, whereas in FIG. 34B showing the second pixel, the resist in the region corresponding to the slit 8a of is removed.

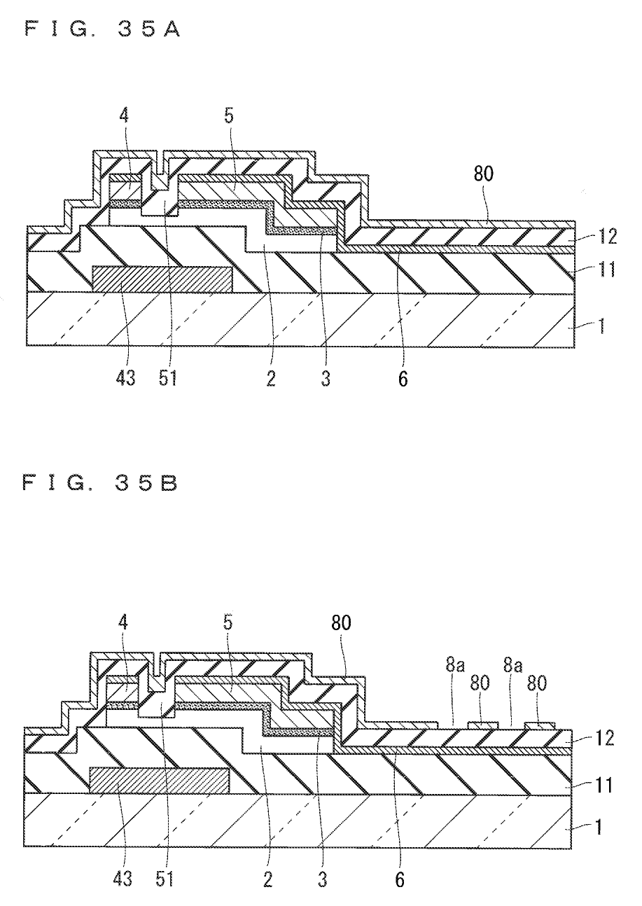

FIGS. 35A and 35B show a state where the second transparent conductive film is subsequently etched and then the resist PR is removed. Even in the case of using the manufacturing method according to the third preferred embodiment, it is possible to manufacture a structure in which no slit is formed in the counter electrode of the first pixel alone specified as a pixel causing a bright spot defect. This makes it possible to repair a bright spot defect to a black spot defect.

This third preferred embodiment exhibits an effect that a bright spot defect can be repaired to a black spot defect similarly to the first and second preferred embodiments, by simply changing the exposure method in the photoengraving process without adding a new process such as locally crystallizing the transparent conductive film or forming a new film. Further, while addition of a new process may cause another defect, this third preferred embodiment is superior in that such possibility is remarkably low.

Method of identifying pixel in which bright spot defect is to occur In the first to third preferred embodiments, the description has been given to the manufacturing methods in which the first pixel that is a pixel in which a bright spot defect is to occur is specified in advance before the repair, and the first pixel alone is locally repaired to a black spot defect. Hereinafter, a method of specifying such a first pixel will be described.

As a method of specifying the first pixel 47 becoming a bright spot described above, generally, characteristic defects are extracted by a pattern defect inspection apparatus, an optical inspection apparatus, or an electrical inspection apparatus in order to specify a pixel becoming a bright spot. Although there are a plurality of modes of defects that can cause a bright spot defect, in most of the defects, the source wiring and the drain electrode are electrically short-circuited by the conductive film.

The source wiring and the drain electrode are typically connected exclusively via a channel region of the thin film transistor. However, in a pixel that may cause a bright spot defect, there is another path for electrically short-circuiting the both, in the channel region or a part other than the channel region. Since the drain electrode and the pixel electrode are typically connected electrically, a bright spot defect can also be caused similarly by a short-circuit of the source wiring and the pixel electrode, for example. Such a path may be a conductive film mainly forming an ohmic contact film, a pixel electrode, and a source wiring. Hereinafter, description will be made for each defect mode.

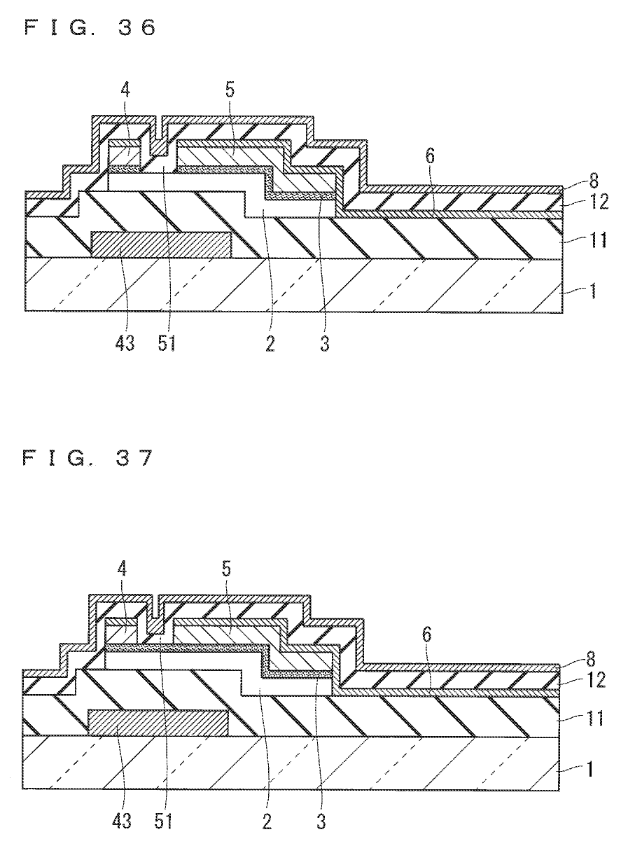

FIGS. 36 to 42 show defect modes that mainly cause a bright spot pixel in an array process. FIGS. 36 to 38 show modes in which the source electrode 4 and the drain electrode 5 are electrically connected. FIGS. 39 to 42 show modes in which the source wiring 44 and the pixel electrode 6 are electrically connected. FIGS. 36 to 38 are cross-sectional views of the TFT to pixel electrode part, corresponding to the cross section taken along line A1-A2 in FIG. 2 or FIG. 3. FIGS. 39 to 42 are cross-sectional views of the source wiring/pixel electrode part, corresponding to the cross section taken along line B1-B2 of FIG. 2 or FIG. 3.

Bright Spot Mode 1

The pixel 47 becoming a bright spot is caused when the semiconductor film 2 between the source electrode 4 and the drain electrode 5 remains without being etched by a proper amount (FIG. 36). In this mode shown in FIG. 36, the path for electrically short-circuiting the source wiring 44 and the drain electrode 5 is considered to be the ohmic contact film partially remaining in the channel region 51. Through such a path, a display voltage is always applied from the source wiring to the pixel electrode via the drain electrode, to cause a bright spot defect. For detecting this bright spot mode 1 by, for example, an optical defect inspection apparatus, it is desirable to detect from the viewpoint of whether there is discoloration or the like in the channel region 51.

Bright Spot Mode 2

The pixel 47 becoming a bright spot is caused when the ohmic contact film 3 between the source electrode 4 and the drain electrode 5 remains (FIG. 37). In this mode shown in FIG. 37, the path for electrically short-circuiting the source wiring and the drain electrode is the ohmic contact film remaining in the channel region 51. Through such a path, a display voltage is always applied from the source wiring to the pixel electrode via the drain electrode, to cause a bright spot defect. For detecting this bright spot mode 2 by, for example, an optical defect inspection apparatus, it is desirable to detect from the viewpoint of whether there is discoloration or the like in the channel region 51.

Bright Spot Mode 3

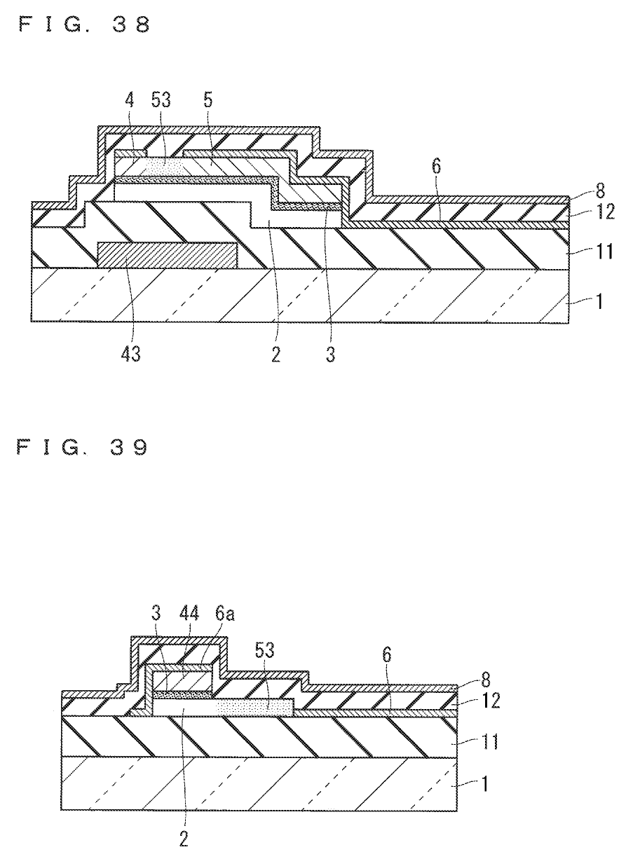

The pixel 47 becoming a bright spot is caused when a metal film between the source electrode 4 and the drain electrode 5 is connected (FIG. 38). In FIG. 38, a pattern abnormal part 53 is formed between the source electrode 4 and the drain electrode 5, and is integrally formed with the source electrode 4 and the drain electrode 5. In this mode shown in FIG. 38, the path for electrically short-circuiting the source wiring and the drain electrode is the pattern abnormal part 53, specifically, the metal film remaining in the channel region. In the first preferred embodiment, the second metal film corresponds.

Through such a path, a display voltage is always applied from the source wiring to the pixel electrode via the drain electrode, to cause a bright spot defect. For detecting this bright spot mode 3 by, for example, an optical defect inspection apparatus, it is desirable to detect from the viewpoint whether there is a pattern of the second metal film 40 over the source electrode 4 and the drain electrode 5, in the channel region 51.

Bright Spot Mode 4

The pixel 47 becoming a bright spot is caused when the semiconductor film 2 in a lower layer of the source wiring 44 is connected to the pixel electrode 6 (FIG. 39). In FIG. 39, the pattern abnormal part 53 is formed between the semiconductor film 2 and the pixel electrode 6, and is integrally formed with the semiconductor film 2. In this mode shown in FIG. 39, the path for electrically short-circuiting the source wiring and the pixel electrode is the semiconductor film. Specifically, the path is a silicon film or an oxide semiconductor film. In the first preferred embodiment, the semiconductor film 2 corresponds.

Since the semiconductor film 2 typically has a high resistance, a display voltage is not always applied from the source wiring to the pixel electrode by simply connecting. However, when the semiconductor film, which is incorporated as the display apparatus and applied with light from the backlight, is irradiated, and the conductivity of the semiconductor film is increased due to generation of optical carriers, the display voltage is always applied from the source wiring to the pixel electrode via the semiconductor film. Therefore, a bright spot defect also occurs in this case. In other words, in a case where the semiconductor film is formed in a light transmitting part, the semiconductor film can also be a conductive film constituting a short-circuit path causing a bright spot defect. For detecting this bright spot mode 4 by, for example, an optical defect inspection apparatus, it is desirable to detect from the viewpoint of whether there is a pattern of the semiconductor film 2 over the pixel electrode 6 and the source wiring 44.

Bright Spot Mode 5

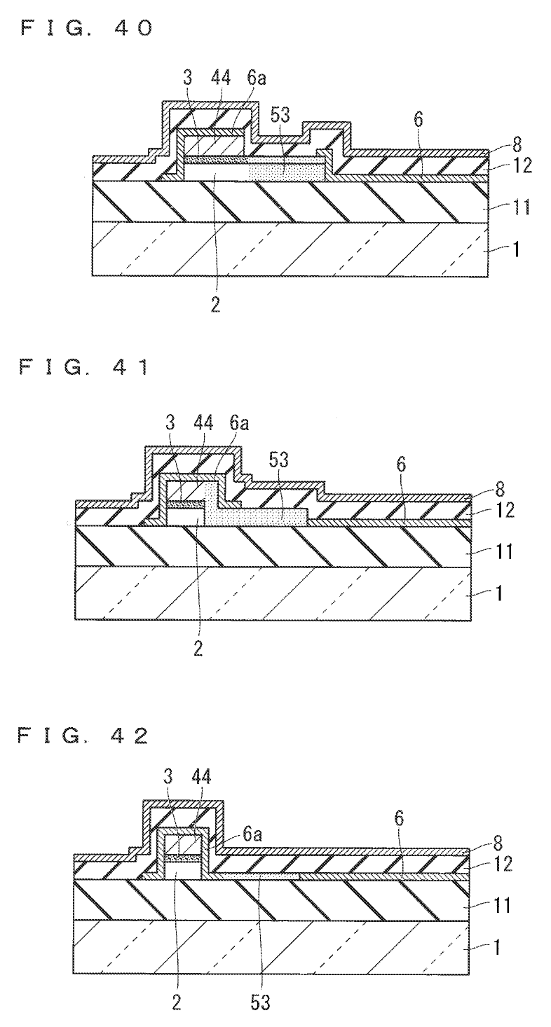

The pixel 47 becoming a bright spot is caused when the ohmic contact film 3 in a lower layer of the source wiring 44 is connected to the pixel electrode 6 (FIG. 40). In FIG. 40, the pattern abnormal part 53 is formed between the pixel electrode 6 and a lamination of the semiconductor film 2 and the ohmic contact film 3, and is formed integrally with the lamination of the semiconductor film 2 and the ohmic contact film 3. In this mode shown in FIG. 40, the path for electrically short-circuiting the source wiring and the pixel electrode is mainly the ohmic contact film.

Since the ohmic contact film is a conductive film, a display voltage is always applied from the source wiring to the pixel electrode through such a path, to cause a bright spot defect. For detecting this bright spot mode 5 by, for example, an optical defect inspection apparatus, it is desirable to detect from the viewpoint of whether there is a pattern of the ohmic contact film 3 over the pixel electrode 6 and the source wiring 44.

Bright Spot Mode 6

The pixel 47 becoming a bright spot is caused when the source wiring 44 and the pixel electrode 6 are connected (FIG. 41). FIG. 41 shows the pattern abnormal part 53 of the source wiring 44. In this mode, the path for electrically short-circuiting the source wiring and the pixel electrode is the second metal film integrally formed with the source wiring. Through such a path, a display voltage is always applied from the source wiring to the pixel electrode, to cause a bright spot defect. For detecting this bright spot mode 6 by, for example, an optical defect inspection apparatus, it is desirable to detect from the viewpoint of whether there is a pattern of the second metal film over the pixel electrode 6 and the source wiring 44.

Bright Spot Mode 7

The pixel 47 becoming a bright spot is caused when the transparent conductive film 6a in an upper layer of the source wiring 44 is connected to the pixel electrode 6 (FIG. 42). Similarly to FIG. 41, FIG. 42 shows the pattern abnormal part 53 of the source wiring. However, in this mode, the path for electrically short-circuiting the source wiring and the pixel electrode is not a metal film, but the transparent conductive film 6a formed integrally with the source wiring. In the first preferred embodiment, the first transparent conductive film pattern 6a corresponds. Through such a path, a display voltage is always applied from the source wiring to the pixel electrode, to cause a bright spot defect. For detecting this bright spot mode 7 by, for example, an optical defect inspection apparatus, it is desirable to detect from the viewpoint of whether there is a pattern of the second transparent conductive film 80 over the pixel electrode 6 and the source wiring 44.

As the process of detecting the pixel (first pixel) becoming a bright spot described above, specification is possible before the implementation of the first to third preferred embodiments. However, the detection is not possible when a conductive film causing a bright spot has not been formed. A desirable process for detection is desirably after pattern formation of the pixel electrode 6 or after pattern formation of the interlayer insulating film 12. This is because all modes of the bright spot modes 1 to 7 can be detected.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display apparatus comprising:
a gate wiring and a source wiring that cross each other in a display area of an array substrate;
a pixel, in the display area, having at least one switching element connected to the gate wiring and the source wiring, and a pixel electrode; and
a counter electrode facing the pixel electrode via an insulating film, wherein
a slit is formed in at least one of the pixel electrode and the counter electrode,
the pixel includes a first pixel and a second pixel, and
an area of a slit of the first pixel is less than 10% of an area of a slit of the second pixel.

2. The liquid crystal display apparatus according to claim 1, wherein a slit is not formed in the first pixel.

3. The liquid crystal display apparatus according to claim 1, wherein
the switching element further includes a source electrode electrically connected to the source wiring, and a drain electrode electrically connected to the pixel electrode, and
in the first pixel, the source electrode or the source wiring is connected to the drain electrode or the pixel electrode via a conductive film.

4. The liquid crystal display apparatus according to claim 3, wherein the conductive film includes any of a semiconductor film added with an impurity, a metal film, a transparent conductive film, and an oxide semiconductor film.

5. The liquid crystal display apparatus according to claim 3, wherein the conductive film is a semiconductor film and is formed in a light transmitting part.

6. A method for manufacturing a liquid crystal display apparatus, the method comprising the steps of:
forming a gate wiring on a substrate;
forming a semiconductor film;
forming a source wiring to cross the gate wiring via a first insulating film;
forming a pixel electrode;
forming an interlayer insulating film; and
forming a counter electrode to face the pixel electrode via the interlayer insulating film, wherein
any one of the pixel electrode and the counter electrode has a slit,
a switching element in which a source electrode electrically connected to the source wiring and a drain electrode electrically connected to the pixel electrode are electrically connected to the semiconductor film, and
an area of a slit of a first pixel is less than 10% of an area of a slit of a second pixel.

7. The method for manufacturing the liquid crystal display apparatus according to claim 6, wherein a slit is not formed in the first pixel.

8. The method for manufacturing the liquid crystal display apparatus according to claim 6, further comprising the step of providing an etching inhibition layer in a region corresponding to the slit in the first pixel, in forming an electrode having the slit out of the pixel electrode or the counter electrode.

9. The method for manufacturing the liquid crystal display apparatus according to claim 8, wherein
an electrode having an upper slit out of the pixel electrode or the counter electrode is formed by formation of an amorphous transparent conductive film, and
the etching inhibition layer is a crystallized transparent conductive film.

10. The method for manufacturing the liquid crystal display apparatus according to claim 9, further comprising the step of forming the etching inhibition layer by irradiating the amorphous transparent conductive film with laser light.

11. The method for manufacturing the liquid crystal display apparatus according to claim 9, wherein in forming the electrode having the slit out of the pixel electrode or the counter electrode, etching is performed with an etching solution having a higher etching rate of an amorphous transparent conductive film than an etching rate of a crystallized transparent conductive film.

12. The method for manufacturing the liquid crystal display apparatus according to claim 8, wherein the etching inhibition layer is an insulating film.

13. The method for manufacturing the liquid crystal display apparatus according to claim 8, wherein the etching inhibition layer is a negative resist.

14. The method for manufacturing the liquid crystal display apparatus according to claim 13, wherein the etching inhibition layer is formed by additional exposure to the first pixel.

15. The method for manufacturing the liquid crystal display apparatus according to claim 6, wherein in the first pixel, the source electrode or the source wiring is connected to the drain electrode or the pixel electrode via a conductive film.

16. The method for manufacturing the liquid crystal display apparatus according to claim 15, wherein the conductive film includes any of a semiconductor film added with an impurity, a metal film, a transparent conductive film, and an oxide semiconductor film.

17. The method for manufacturing the liquid crystal display apparatus according to claim 15, wherein the conductive film is a semiconductor film and is formed in a light transmitting part.
